(19) United States
(12) Patent Application Publication
(10) Pub. No.: US 2026/0247243 A1
(43) Pub. Date: Aug. 20, 2026

(54) METHOD OF USER EQUIPMENT, METHOD OF COMMUNICATION APPARATUS, UE AND COMMUNICATION APPARATUS

(71) Applicant: NEC Corporation, Tokyo (JP)

(72) Inventors: Toshiyuki TAMURA, Ibaraki (JP); Kundan TIWARI, Bengaluru (IN); Iskren IANEV, Reading (GB); Jasmina MCMENAMY, Berlin (DE); Hisashi FUTAKI, Tokyo (JP)

(73) Assignee: NEC Corporation, Tokyo (JP)

(21) Appl. No.: 19/160,684

(22) PCT Filed: Mar. 4, 2024
(86) PCT No.: PCT/JP2024/007952

§ 371 Date: Aug. 28, 2025

(30) Foreign Application Priority Data
Mar. 9, 2023 (IN) 202311015789

(51) Int. Cl. H04W 36/14

(52) U.S. Cl. CPC H04W 36/142

(57) ABSTRACT

An aspect of this disclosure includes a method of a user equipment (UE). The method includes communicating with a communication apparatus. The method includes keeping staying in a first Public Land Mobile Network (PLMN) by stopping a timer or by ignoring expiry of the timer or by overriding the timer in a case where the UE is in the first PLMN and a second PLMN. The timer is configured to make the UE to return to the second PLMN in a case of expiry of the timer. The second PLMN is a Home Public Land Mobile Network (HPLMN) of the UE.

### TECHNICAL FIELD

The present disclosure relates to a method of a user equipment (UE), a method of a communication apparatus, a UE and a communication apparatus and so on.

### BACKGROUND ART

According to 3GPP TR 22.877 [2], 3GPP SA1 group captures a new service requirement for subscriber management as summarized below.
The 5G system shall be able to support a mechanism for forwarding signalling traffic pertaining to UEs of specific subscribers from their HPLMN to a target PLMN, e.g., to enable further handling of those UEs by the target PLMN. The forwarding mechanism shall minimize signalling traffic in the HPLMN, e.g., by using efficient means to forward traffic from selected UEs.

This service requirement comes from the fact that PLMN operators may have a special relationship with another PLMN operator per subscriber. For example, it assumes that one PLMN operator acquires another PLMN operator while the another PLMN operator provides a unique service to their subscribers. In this case those subscribers should continue to have the unique service from the network in the another PLMN operator even those subscribers belong to the one PLMN.

### CITATION LIST

### Non Patent Literature

NPL 1: 3GPP TR 21.905: “Vocabulary for 3GPP Specifications”. V17.1.0 (2021 December)
NPL 2: 3GPP TR 22.877: “Study on Roaming Value-Added Services”. V19.0.0 (2022 December)
NPL 3: 3GPP TS 23.501: “System architecture for the 5G System (5GS)”. V18.0.0 (2022 December)
NPL 4: 3GPP TS 23.502: “Procedures for the 5G System (5GS)”. V18.0.0 (2022 December)
NPL 5: 3GPP TS 23.503: “Policy and charging control framework for the 5G System (5GS) Stage 2”. V18.0.0 (2022 December)
NPL 6: 3GPP TS 24.501: “Non-Access-Stratum (NAS) protocol for 5G System (5GS) Stage 3”. V18.1.0 (2022 December)
NPL 7: 3GPP TS 23.122: “Non-Access-Stratum (NAS) functions related to Mobile Station (MS) in idle mode”. V18.1.0 (2022 December)

### SUMMARY OF INVENTION

### Technical Problem

According to the latest 3GPP mobility management functionalities, as defined in for example 3GPP TS 23.501 [3], one operator cannot steer the UE moving to another PLMN while the UE is in a home network environment. I.e., as far as the UE can find the HPLMN, the UE has to stay in the HPLMN.

This is a limitation in 3GPP standard(s) in a case where one operator wishes to move the UE to another PLMN while the UE is in the coverage of the HPLMN. Hence, for example, due to this limitation, the latest 3GPP specification(s) may not meet the new service requirement, and this limitation prevents operators from achieving a flexible service deployment scenario, for example based on the business relationship among the operators.

For example, this disclosure focuses on the following limitation as operational problem in the latest 3GPP mobility management functionalities. Due to this limitation, for example, the latest 3GPP specification(s) may not meet the new service requirement. For example, a UE may not be able to keep staying in a PLMN which is different from the HPLMN of the UE. Hence it needs to improve the latest 3GPP mobility management functionalities.
Operational problem: According to the latest 3GPP mobility management functionalities, the UE has to stay in a cell that broadcasts a PLMN ID of an HPLMN as far as the UE can access to that cell. I.e., (1) the UE has to stay in the cell that broadcasts the PLMN ID of the HPLMN, and (2) the UE has to move back to the cell that broadcasts the PLMN ID of the HPLMN when the UE is in a cell that does not broadcast the PLMN ID of the HPLMN.

### Solution to Problem

A method of a user equipment (UE), the method includes:
communicating with a communication apparatus; and
keeping staying in a first Public Land Mobile Network (PLMN) by stopping a timer or by ignoring expiry of the timer or by overriding the timer in a case where the UE is in the first PLMN and a second PLMN,
wherein the timer is configured to make the UE to return to the second PLMN in a case of expiry of the timer, and
wherein the second PLMN is a Home Public Land Mobile Network (HPLMN) of the UE.

A method of a user equipment (UE), the method includes:
communicating with a communication apparatus; and
keeping staying in a first Public Land Mobile Network (PLMN) by using a PLMN list related to a Roaming Value Added Service (RVAS) in a case where the UE is in the first PLMN and a second PLMN,
wherein the first PLMN is included in the PLMN list,
wherein the PLMN list indicates that the first PLMN is selected for the RVAS in preference to the second PLMN, and
wherein the second PLMN is a Home Public Land Mobile Network (HPLMN) of the UE.

A user equipment (UE) includes:
means for communicating with a communication apparatus; and
means for keeping staying in a first Public Land Mobile Network (PLMN) by stopping a timer or by ignoring expiry of the timer or by overriding the timer in a case where the UE is in the first PLMN and a second PLMN,
wherein the timer is configured to make the UE to return to the second PLMN in a case of expiry of the timer, and
wherein the second PLMN is a Home Public Land Mobile Network (HPLMN) of the UE.

A user equipment (UE) includes:
means for communicating with a communication apparatus; and
means for keeping staying in a first Public Land Mobile Network (PLMN) by using a PLMN list related to a Roaming Value Added Service (RVAS) in a case where the UE is in the first PLMN and a second PLMN,
wherein the first PLMN is included in the PLMN list,
wherein the PLMN list indicates that the first PLMN is selected for the RVAS in preference to the second PLMN, and
wherein the second PLMN is a Home Public Land Mobile Network (HPLMN) of the UE.

A method of a communication apparatus in a first Public Land Mobile Network (PLMN) includes:
communicating with a user equipment (UE); and
sending, to the UE, information to indicate to stop a timer or to ignore expiry of the timer or to override the timer,
wherein the timer is configured to make the UE to return to a second PLMN in a case of expiry of the timer, and
wherein the second PLMN is a Home Public Land Mobile Network (HPLMN) of the UE.

A communication apparatus in a first Public Land Mobile Network (PLMN) includes:
means for communicating with a user equipment (UE); and
means for sending, to the UE, information to indicate to stop a timer or to ignore expiry of the timer or to override the timer,
wherein the timer is configured to make the UE to return to a second PLMN in a case of expiry of the timer, and
wherein the second PLMN is a Home Public Land Mobile Network (HPLMN) of the UE.

A method of a communication apparatus in a first Public Land Mobile Network (PLMN) includes:
communicating with a user equipment (UE); and
sending a PLMN list related to a Roaming Value Added Service (RVAS) to make the UE to stay in the first PLMN,
wherein the first PLMN is included in the PLMN list,
wherein the PLMN list indicates that the first PLMN is selected for the RVAS in preference to a second PLMN, and
wherein the second PLMN is a Home Public Land Mobile Network (HPLMN) of the UE.

A communication apparatus in a first Public Land Mobile Network (PLMN) includes:
means for communicating with a user equipment (UE); and
means for sending a PLMN list related to a Roaming Value Added Service (RVAS) to make the UE to stay in the first PLMN,
wherein the first PLMN is included in the PLMN list,
wherein the PLMN list indicates that the first PLMN is selected for the RVAS in preference to a second PLMN, and
wherein the second PLMN is a Home Public Land Mobile Network (HPLMN) of the UE.

A method of a communication apparatus in a first Public Land Mobile Network (PLMN) includes:
communicating with a user equipment (UE); and
sending first information regarding a second PLMN other than the first PLMN and second information regarding a frequency band,
wherein the first information indicates the second PLMN in which the UE needs to stay, and
wherein the second information indicate the frequency band which the UE needs to scan.

A communication apparatus in a first Public Land Mobile Network (PLMN) includes:
means for communicating with a user equipment (UE); and
means for sending first information regarding a second PLMN other than the first PLMN and second information regarding a frequency band,
wherein the first information indicates the second PLMN in which the UE needs to stay, and
wherein the second information indicate the frequency band which the UE needs to scan.

### BRIEF DESCRIPTION OF DRAWINGS

FIG. 1 is a signaling diagram of a First example of the First Aspect.

FIG. 2 is a signaling diagram of a Second example of the First Aspect.

FIG. 3 is a signaling diagram of a Third example of the First Aspect.

FIG. 4 is a signaling diagram of a Fourth example of the First Aspect.

FIG. 5 is a signaling diagram of a Fifth example of the First Aspect.

FIG. 6 is a signaling diagram of a Sixth example of the First Aspect.

FIG. 7 is a signaling diagram of a Seventh example of the First Aspect.

FIG. 8 is a signaling diagram of an Eighth example of the First Aspect.

FIG. 9 is a signaling diagram of a First example of the Second Aspect.

FIG. 10 is a signaling diagram of a Second example of the Second Aspect.

FIG. 11 is a signaling diagram of a Third example of the Second Aspect.

FIG. 12 is a signaling diagram of a Fourth example of the Second Aspect.

FIG. 13 is a diagram illustrating a system overview.

FIG. 14 is a block diagram illustrating a UE.

FIG. 15 is a block diagram illustrating an (R)AN node.

FIG. 16 is a diagram illustrating System overview of (R)AN node based on O-RAN architecture.

FIG. 17 is a block diagram illustrating an RU.

FIG. 18 is a block diagram illustrating a DU.

FIG. 19 is a block diagram illustrating a CU.

FIG. 20 is a block diagram illustrating an AMF.

FIG. 21 is a block diagram illustrating an SMF.

FIG. 22 is a block diagram illustrating a PCF.

FIG. 23 is a block diagram illustrating an AUSF.

FIG. 24 is a block diagram illustrating a UDM.

FIG. 25 is a block diagram illustrating an NSSF.

### DESCRIPTION OF EMBODIMENTS

### Abbreviations

For the purposes of the present document, the abbreviations given in 3GPP TR 21.905 [1] and the following apply. An abbreviation defined in the present document takes precedence over the definition of the same abbreviation, if any, in 3GPP TR 21.905 [1].

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN | PDB 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QoS Identifier |
| AF | Application Function |
| AMF | Access and Mobility Management Function |
| AMF-G | Geographically selected Access and |
| | Mobility Management Function |
| AMF-NG | Non-Geographically selected Access and |
| | Mobility Management Function |
| ANDSF | Access Network Discovery and Selection Function |
| ARFCN | Absolute radio-frequency channel number |
| AS | Access Stratum |
| ASN | Abstract Syntax Notation |
| ATSSS | Access Traffic Steering, Switching, Splitting |
| ATSSS-LL | ATSSS Low-Layer |
| AuC | Authentication Centre |
| AUSF | Authentication Server Function |
| AUTN | Authentication token |
| BCCH | Broadcast Control Channel |
| BMCA | Best Master Clock Algorithm |
| BSF | Binding Support Function |
| CAG | Closed Access Group |
| CAPIF | Common API Framework for 3GPP |
| | northbound APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| G-PDU | GTP encapsulated user Plane Data Unit |
| GPS | Global Positioning System |
| GPSI | Generic Public Subscription Identifier |
| GUAMI | Globally Unique AMF Identifier |
| GUTI | Globally Unique Temporary UE Identity |
| HPLMN | Home Public Land Mobile Network |
| HR | Home Routed (roaming) |
| HSS | Home Subscriber Server |
| IAB | Integrated access and backhaul |
| IPsec | Internet Protocol Security |
| IMEI/TAC | IMEI Type Allocation Code |
| IMSI | International Mobile Subscriber Identity |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| ME | Mobile Equipment |
| MFBR | Maximum Flow Bit Rate |
| MICO | Mobile Initiated Connection Only |
| MINT | Minimization of service interruption |
| MITM | Man In the Middle |
| MME | Mobility Management Entity |
| MNC | Mobile Network Code |
| MOCN | Multiple Operator Core Network |
| MPS | Multimedia Priority Service |
| MPTCP | Multi-Path TCP Protocol |
| MT | Mobile Termination |
| N3IWF | Non-3GPP Inter Working Function |
| N3GPP | Non-3GPP access |
| N5CW | Non-5G-Capable over WLAN |
| NAI | Network Access Identifier |
| NAS | Non-Access-Stratum |
| NEF | Network Exposure Function |
| NF | Network Function |
| NGAP | Next Generation Application Protocol |
| NID | Network identifier |
| NMEA | National Marine Electronics Association |
| NPN | Non-Public Network |
| NR | New Radio |
| NSAG | Network Slice Access Stratum Group |
| NRF | Network Repository Function |
| NSI ID | Network Slice Instance Identifier |
| NSSAA | Network Slice-Specific Authentication |
| | and Authorization |
| NSSAAF | Network Slice-Specific Authentication |
| | and Authorization Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PCO | Protocol Configuration Options |
| PCRF | Policy and Charging Rules Function |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RAT | Radio Access Technology |
| RG | Residential Gateway |
| RIM | Remote Interference Management |
| RQA | Reflective QoS Attribute |
| RQI | Reflective QoS Indication |
| RRC | Radio Resource Control |
| RSN | Redundancy Sequence Number |
| RSRP | Reference Signal Received Power |
| RSRQ | Reference Signal Received Quality |
| RVAS | Roaming Value Added Service |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SENSE | Signal Level Enhanced Network Selection |
| SEPP | Security Edge Protection Proxy |
| SGW | Serving Gateway |
| SIB | System Information Block |
| SINR | Signal to Interference plus Noise Ratio |
| SMF | Session Management Function |
| SMSF | Short Message Service Function |
| SN | Sequence Number |
| SN name | Serving Network Name. |
| SNPN | Stand-alone Non-Public Network |
| S-NSSAI | Single Network Slice Selection |
| | Assistance Information |
| SOR | Steering of Roaming |
| SSC | Session and Service Continuity |
| SSCMSP | Session and Service Continuity |
| | Mode Selection Policy |
| SST | Slice/Service Type |
| SUCI | Subscription Concealed Identifier |
| SUPI | Subscription Permanent Identifier |
| SV | Software Version |
| TAU | Tracking Area Update |
| TEID | Tunnel Endpoint Identifier |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UPF | User Plane Function |
| UPSI | UE Policy Section Identifier |
| URLLC | Ultra Reliable Low Latency Communication |
| URRP-AMF | UE Reachability Request Parameter for AMF |
| URSP | UE Route Selection Policy |
| USIM | User Services Identity Module |
| VID | VLAN Identifier |
| VLAN | Virtual Local Area Network |
| VPLMN | Visited Public Land Mobile Network |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### Definitions

For the purposes of the present document, the terms and definitions given in 3GPP TR 21.905 [1] and the following apply. A term defined in the present document takes precedence over the definition of the same term, if any, in 3GPP TR 21.905 [1].

### CITATION LIST

[1] 3GPP TR 21.905: “Vocabulary for 3GPP Specifications”. V17.1.0 (2021 December)
[2] 3GPP TR 22.877: “Study on Roaming Value-Added Services”. V19.0.0 (2022 December)
[3] 3GPP TS 23.501: “System architecture for the 5G System (5GS)”. V18.0.0 (2022 December)
[4] 3GPP TS 23.502: “Procedures for the 5G System (5GS)”. V18.0.0 (2022 December)
[5] 3GPP TS 23.503: “Policy and charging control framework for the 5G System (5GS) Stage 2”. V18.0.0 (2022 December)
[6] 3GPP TS 24.501: “Non-Access-Stratum (NAS) protocol for 5G System (5GS) Stage 3”. V18.1.0 (2022 December)
[7] 3GPP TS 23.122: “Non-Access-Stratum (NAS) functions related to Mobile Station (MS) in idle mode”. V18.1.0 (2022 December)

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects (e.g., First Aspect, Second Aspect, First example of the First Aspect, Second example of the First Aspect, Third example of the First Aspect, Fourth example of the First Aspect, Fifth example of the First Aspect, Sixth example of the First Aspect, Seventh example of the First Aspect, Eighth example of the First Aspect, First example of the Second Aspect, Second example of the Second Aspect, Third example of the Second Aspect, Fourth example of the Second Aspect, Variant(s) of each Aspects) and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

Any lists described in following aspects include at least one parameter or multiple parameters. Although this disclosure includes a mechanism to steer the UE to another PLMN while the UE in the home network environment (e.g., HPLMN) in the 5GS, all mechanisms in this disclosure can apply to the EPS as well. In case all mechanisms in this disclosure are to apply to the EPS, the following terminology conversions apply:

```
  gNB → eNodeB
  AMF → MME
  NGAP → S1AP
  Any NGAP messages → Respective S1AP messages
  Registration Request message → Attach Request message or TAU
  Request
message
  Any AMF service-related messages (e.g.,
Namf_Communication_NonUeN2InfoNotify) → GTP-C messages
  Any UDM service-related messages (e.g., Nudm_SDM_Notification)
→ DIAMETER messages
  5G-GUTI → GUTI
  5G-S-TMSI → S-TMSI
```

An expression “A and/or B” may mean “at least one of A and B” in this disclosure.

In this disclosure, user(s), subscriber(s), UE(s) and similar term(s) may have same meanings. These terms may be replaced each other.

An example object of this disclosure is to provide a method and apparatus that can solve the above problem.

A method of a user equipment (UE) according to example aspect of this disclosure includes communicating with a communication apparatus. The method includes keeping staying in a first Public Land Mobile Network (PLMN) by stopping a timer or by ignoring expiry of the timer or by overriding the timer in a case where the UE is in the first PLMN and a second PLMN. The timer is configured to make the UE to return to the second PLMN in a case of expiry of the timer. The second PLMN is a Home Public Land Mobile Network (HPLMN) of the UE.

A method of a user equipment (UE) according to example aspect of this disclosure includes communicating with a communication apparatus. The method includes keeping staying in a first Public Land Mobile Network (PLMN) by using a PLMN list related to a Roaming Value Added Service (RVAS) in a case where the UE is in the first PLMN and a second PLMN.

The first PLMN is included in the PLMN list. The PLMN list indicates that the first PLMN is selected for the RVAS in preference to the second PLMN. The second PLMN is a Home Public Land Mobile Network (HPLMN) of the UE.

A user equipment (UE) according to example aspect of this disclosure includes at least one memory, and at least one hardware processor coupled to the at least one memory. The at least one hardware processor is configured to communicate with a communication apparatus. The at least one hardware processor is configured to keep staying in a first Public Land Mobile Network (PLMN) by stopping a timer or by ignoring expiry of the timer or by overriding the timer in a case where the UE is in the first PLMN and a second PLMN. The timer is configured to make the UE to return to the second PLMN in a case of expiry of the timer. The second PLMN is a Home Public Land Mobile Network (HPLMN) of the UE.

A user equipment (UE) according to example aspect of this disclosure includes at least one memory, and at least one hardware processor coupled to the at least one memory. The at least one hardware processor is configured to communicate with a communication apparatus. The at least one hardware processor is configured to keep staying in a first Public Land Mobile Network (PLMN) by using a PLMN list related to a Roaming Value Added Service (RVAS) in a case where the UE is in the first PLMN and a second PLMN. The first PLMN is included in the PLMN list. The PLMN list indicates that the first PLMN is selected for the RVAS in preference to the second PLMN. The second PLMN is a Home Public Land Mobile Network (HPLMN) of the UE.

A method of a communication apparatus in a first Public Land Mobile Network (PLMN) according to example aspect of this disclosure includes communicating with a user equipment (UE). The method includes sending, to the UE, information to indicate to stop a timer or to ignore expiry of the timer or to override the timer. The timer is configured to make the UE to return to a second PLMN in a case of expiry of the timer. The second PLMN is a Home Public Land Mobile Network (HPLMN) of the UE.

A communication apparatus in a first Public Land Mobile Network (PLMN) according to example aspect of this disclosure includes at least one memory, and at least one hardware processor coupled to the at least one memory. The at least one hardware processor is configured to communicate with a user equipment (UE). The at least one hardware processor is configured to send, to the UE, information to indicate to stop a timer or to ignore expiry of the timer or to override the timer. The timer is configured to make the UE to return to a second PLMN in a case of expiry of the timer. The second PLMN is a Home Public Land Mobile Network (HPLMN) of the UE.

A method of a communication apparatus in a first Public Land Mobile Network (PLMN) according to example aspect of this disclosure includes communicating with a user equipment (UE). The method includes sending first information regarding a second PLMN other than the first PLMN and second information regarding a frequency band. The first information indicates the second PLMN in which the UE needs to stay. The second information indicate the frequency band which the UE needs to scan.

A communication apparatus in a first Public Land Mobile Network (PLMN) according to example aspect of this disclosure includes at least one memory, and at least one hardware processor coupled to the at least one memory. The at least one hardware processor is configured to communicate with a user equipment (UE). The at least one hardware processor is configured to send, to the UE, information to indicate to stop a timer or to ignore expiry of the timer or to override the timer. The timer is configured to make the UE to return to a second PLMN in a case of expiry of the timer. The second PLMN is a Home Public Land Mobile Network (HPLMN) of the UE.

A method of a communication apparatus in a first Public Land Mobile Network (PLMN) according to example aspect of this disclosure includes communicating with a user equipment (UE). The method includes sending a PLMN list related to a Roaming Value Added Service (RVAS) to make the UE to stay in the first PLMN. The first PLMN is included in the PLMN list. The PLMN list indicates that the first PLMN is selected for the RVAS in preference to a second PLMN. The second PLMN is a Home Public Land Mobile Network (HPLMN) of the UE.

A communication apparatus in a first Public Land Mobile Network (PLMN) according to example aspect of this disclosure includes at least one memory, and at least one hardware processor coupled to the at least one memory. The at least one hardware processor is configured to communicate with a user equipment (UE). The at least one hardware processor is configured to send first information regarding a second PLMN other than the first PLMN and second information regarding a frequency band. The first information indicates the second PLMN in which the UE needs to stay. The second information indicate the frequency band which the UE needs to scan.

### First Aspect

For example, this disclosure focuses on the following limitation as operational problem in the latest 3GPP mobility management functionalities. Due to this limitation, for example, the latest 3GPP specification(s) may not meet the new service requirement, hence it needs to improve the latest 3GPP functionalities.
Operational problem: According to the latest 3GPP mobility management functionalities, an AMF in an HPLMN of a UE cannot be relocated to another AMF from a PLMN which is different from the HPLMN of the UE. In addition, according to the latest 3GPP functionalities, an AMF in the HPLMN of the UE cannot contact to an SMF in a PLMN which is different from the HPLMN of the UE, and communication to establish PDU session(s) between the HPLMN and the PLMN which is different from the HPLMN of the UE cannot be performed.

This aspect includes mechanisms to (re-)select an AMF (e.g., an AMF 7002) based on the subscription data in a UDM (e.g., a UDM 75). A Segment is maintained by the UDM (e.g., the UDM 75) per subscriber basis. The Segment may indicate a group of subscriber(s) which are eligible to have a unique service(s) that are provided by a designated PLMN (e.g., a designated PLMN 2, or PLMN 2) where the AMF (e.g., the AMF 7002) belongs to. The Segment may indicate the group of subscriber(s) which are eligible to have the unique service(s) and/or an area where the unique services(s) are provided. The Segment may indicate a name of the group of subscriber(s) and/or a name of the area. The Segment may indicate an area in the designated PLMN where the subscriber(s) (or UE(s)) needs to stay.

The Segment may indicate an area in the designated PLMN where the subscriber(s) (or UE(s)) needs to perform a registration procedure. The Segment may be indicated by a certain IMSI range of USIM(s). For example, the group of subscriber(s) may be indicated by the certain IMSI range. For example, the subscriber(s) which are eligible to have the unique service(s) that are provided by the designated PLMN may be identified by a value(s) in the certain IMSI range. For example, at least one of the subscriber(s) which are eligible to have the unique service(s) that are provided by the designated PLMN may be identified by an IMSI (or IMSI range) including MCC which is set to “AAA” (e.g., “AAA” may indicate a country), MNC which is set to “BB” (e.g., “BB” may indicate an operator. For example, the operator may be PLMN 1 or PLMN 2 in this disclosure. “BB” may indicate PLMN 1 or PLMN 2 in this disclosure) and MSIN which is set to one of “9000000000” to “9999999999”. The unique service may be called as Roaming Value Added Service (RVAS) or any other notation for a service which is provided by a designated entity which is not the HPLMN.

For example, this Aspect includes mechanisms that can solve the above identified problem.

### First Example of the First Aspect:

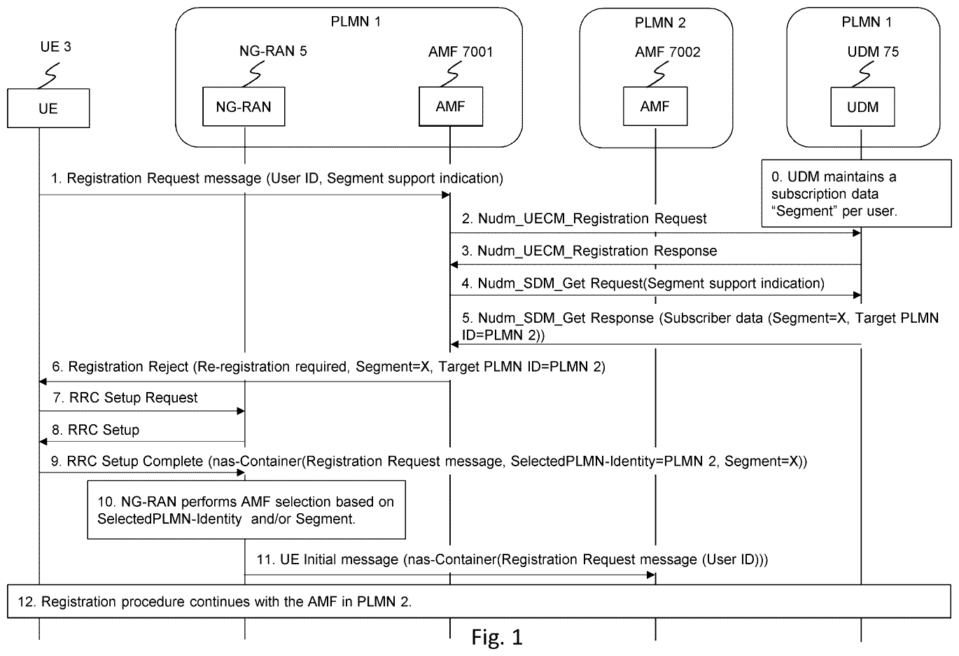

The FIG. 1 includes an example of the AMF (re-)selection by an NG-RAN (e.g., an NG-RAN 5) based on the Segment and/or PLMN ID.

FIG. 1: AMF (Re-)Selection by the NG-RAN 5 Based on the Segment and/or PLMN ID

The detailed processes of the First example of the First Aspect are described below with reference to the FIG. 1.

Step 0. The UDM 75 maintains (or stores) subscription data per user(s). For example, the UDM 75 may maintain information regarding the Segment. For example, the UDM 75 may maintain information indicating whether the user(s) (or UE(s)) is included in the Segment.

For example, the UDM 75 may maintain information indicating whether the user(s) (or UE(s)) is included in the above mentioned certain IMSI range. For example, the UDM 75 may maintain information indicating whether the user(s) (or UE(s)) is a user(s) (or UE(s)) included in the above mentioned certain IMSI range. For example, the UDM 75 may maintain information indicating whether the unique service(s) in the specific PLMN is provided to the user(s) (or UE(s)). For example, in a case where the Segment indicates the area where the unique service(s) is provided, the UDM 75 may maintain information indicating whether the user(s) (or UE(s)) is the user(s) (or UE(s)) in the Segment (or in the area). The user(s) (or UE(s)) may be indicated by User ID(s). For example, the UDM 75 may maintain information indicating whether the user(s) (or UE(s)) is eligible to have the unique service(s). For example, the UDM 75 may maintain information indicating that a UE 3 described below is related to the Segment which is set to “X”. “X” may be a name of the Segment. For example, the UDM 75 may maintain information indicating that the UE 3 is included in the Segment which is set to “X”. For example, the UDM 75 may maintain information indicating that the UE 3 is included in the group of subscriber(s) named as “X”. For example, the UDM 75 may maintain information indicating that the UE 3 is included in the certain IMSI range named as “X”. For example, the UDM 75 may maintain information indicating that the UE 3 is included in or belongs to an area named as “X” where the unique service(s) is provided.

The UDM 75 may be included in PLMN 1.

For example, the UDM 75 in PLMN 1 may maintain information regarding PLMN 2. For example, the UDM 75 may maintain Target PLMN ID per user(s). The Target PLMN ID may be described below. For example, regarding the UE 3 described below, the UDM 75 may maintain information indicating that the UE 3 is included in the Segment “X” and/or information indicating that the UE 3's Target PLMN ID is PLMN 2. “X” may be a name of the Segment.

For example, the UDM 75 may maintain information indicating that the UE 3 has or is included in or belongs to the certain IMSI range as mentioned above. For example, PLMN 1 may be a PLMN which covers an entire area of a country (e.g., PLMN 1 has a coverage area which can cover the entire area of the country), and PLMN 2 may be included in PLMN 1 (e.g., a coverage area of PLMN 2 may be included in a coverage area of PLMN 1), and may cover a specific area of the country (e.g., PLMN 2 has a coverage area which can cover the specific area or a part of the country). PLMN 1 may be different from PLMN 2.

Step 1. The UE 3 sends a Registration Request message to an AMF 7001 via the NG-RAN 5 including User ID and Segment support indication. The User ID indicates the user identity of the UE 3. The User ID can be SUCI, 5G-GUTI, PEI or information identifying the UE 3.

The Segment support indication indicates to the AMF 7001 that the UE 3 supports the AMF (re-)selection function based on the Segment information. The NG-RAN 5 may include an NG-RAN node(s), (R)AN node(s), gNB(s) etc. The NG-RAN 5 and the AMF 7001 may be included in PLMN 1. “The UE 3 supports the AMF (re-)selection function based on the Segment information” may mean that the UE 3 is able to send the Segment support indication. “The XXX (“XXX” is a node e.g., a UE, an AMF, an NG-RAN etc.) supports the AMF (re-)selection function based on the Segment information” may mean that the XXX is able to perform process(es) regarding a selection of an AMF 7002 in PLMN 2 in this disclosure.

Step 2. Upon reception of the Registration Request message in step 1, the AMF 7001 sends an Nudm_UECM_Registration Request message to the UDM 75 in PLMN 1. In one example, the AMF 7001 may include a Segment support indication in the Nudm_UECM_Registration Request message when at least one of the UE 3, the NG-RAN 5 and the AMF 7001 support the AMF (re-)selection function based on the Segment information. The PLMN 1 may be an HPLMN of the UE 3.

For example, the AMF 7001 may include a Segment support indication in the Nudm_UECM_Registration Request message, and send the Nudm_UECM_Registration Request message in a case where the AMF 7001 determines that at least one of the UE 3, the NG-RAN 5 and the AMF 7001 support the AMF (re-)selection function based on the Segment information.

For example, the AMF 7001 may send the Nudm_UECM_Registration Request message including the Segment support indication in a case where the AMF 7001 receives the Segment support indication from the UE 3 in step 1.

The Segment support indication included in the Nudm_UECM_Registration Request message may indicate that at least one of the UE 3, the NG-RAN 5 and the AMF 7001 support the AMF (re-)selection function based on the Segment information.

“The AMF 7001 supports the AMF (re-)selection function based on the Segment information” may mean that the AMF 7001 is able to send the Segment support indication. For example, the AMF 7001 may determine (or learn or know or understand), based on the Segment support indication from the UE 3 in step 1, that the UE 3 supports the AMF (re-)selection function based on the Segment information.

For example, the AMF 7001 may determine that the UE 3 supports the AMF (re-)selection function based on the Segment information in a case where the AMF 7001 receives the Segment support indication from the UE 3.

It may refer to the Third example of the First Aspect how the AMF 7001 determines (or learns or knows or understands) whether the NG-RAN 5 supports the AMF (re-)selection function based on the Segment information. For example, based on process(es) in the Third example of the First Aspect, the AMF 7001 may determine that the NG-RAN 5 supports the AMF (re-)selection function based on the Segment information.

For example, the AMF 7001 may determine that the AMF 7001 itself supports the AMF (re-)selection function based on the Segment information, based on configuration information or an operator's policy or any other information in the AMF 7001. For example, the AMF 7001 may determine that the AMF 7001 itself supports the AMF (re-)selection function in a case where the configuration information or an operator's policy or any other information in the AMF 7001 indicates that the AMF 7001 itself supports the AMF (re-)selection function. For example, the AMF 7001 may be configured to support the AMF (re-)selection function.

Step 3. Upon reception of the Nudm_UECM_Registration Request message in step 2, the UDM 75 sends an Nudm_UECM_Registration Response message to the AMF 7001.

Step 4. The AMF 7001 sends an Nudm_SDM_Get Request message to the UDM 75 in PLMN 1 including the Segment support indication when at least one of the UE 3, NG-RAN 5 and AMF 7001 support the AMF (re-)selection function based on the Segment information. For example, the AMF 7001 may send the Nudm_SDM_Get Request message to the UDM 75 including the Segment support indication.

For example, the AMF 7001 may send the Nudm_SDM_Get Request message to the UDM 75 including the Segment support indication in a case where the AMF 7001 determines that at least one of the UE 3, NG-RAN 5 and AMF 7001 support the AMF (re-)selection function based on the Segment information.

For example, the AMF 7001 may send the Nudm_SDM_Get Request message to the UDM 75 in PLMN 1 including the Segment support indication in a case where the AMF 7001 receives at least one of the Segment support indication from the UE 3 and the Segment support information from the NG-RAN 5.

For example, the AMF 7001 may send the Nudm_SDM_Get Request message in a case where the AMF 7001 receives the Nudm_UECM_Registration Response message.

The Segment support indication included in the Nudm_SDM_Get Request message may indicate that at least one of the UE 3, the NG-RAN 5 and the AMF 7001 support the AMF (re-)selection function based on the Segment information.

Step 5. Upon reception of the Nudm_SDM_Get Request message in step 4, the UDM 75 sends an Nudm_SDM_Get Response message including Subscriber Data to the AMF 7001.

The Subscriber Data in Nudm_SDM_Get Response message may include Segment information and/or Target PLMN ID. The Subscriber Data in Nudm_SDM_Get Response message may include the Segment information for the UE 3 and/or Target PLMN ID for the UE 3.

If the Segment support indication was indicated in the Nudm_SDM_Get Request message in step 4 and the UDM 75 maintains information indicating the UE 3 supports the AMF (re-)selection function based on the Segment information in the Subscriber Data for the UE 3, the Subscriber Data in Nudm_SDM_Get Response message may include Segment information and/or Target PLMN ID. For example, in a case where the Segment support indication was indicated in the Nudm_SDM_Get Request message in step 4, the Subscriber Data in Nudm_SDM_Get Response message may include Segment information and/or Target PLMN ID.

For example, the Segment information may be information regarding the Segment.

The Segment information may be expressed by a numeric number or a letter that can distinguish in the PLMN an PLMN associated with the Segment. The Segment information may be expressed differently. For example, the Segment information may include or may be a segment identifier in the FQDN format, a PLMN Identifier including MCC and MNC, both the PLMN Identifier and the segment identifier, etc. For example, the Segment information may indicate that the UE 3 is in the above mentioned certain IMSI range. For example, the Segment information may indicate that the UE 3 is a UE in the above-mentioned certain IMSI range. For example, the Segment information may indicate that the UE 3 is in the Segment. For example, the Segment information may indicate that the UE 3 is a UE in the above-mentioned Segment. For example, the Segment information may indicate that the UE 3 is included in is included in or belongs to an area where the above-mentioned unique service(s) is provided. For example, the Segment information may indicate that the UE 3 is eligible to have the above-mentioned unique service(s). For example, the Segment information may indicate that the UE 3 is included in the above-mentioned group of subscriber(s).

The Target PLMN ID may be a PLMN Identifier including MCC and MNC. The Target PLMN ID may be or may include information identifying a PLMN. The Target PLMN ID may indicate that a PLMN to which the UE 3 needs to register or to perform a Registration Procedure. The Target PLMN ID may indicate that a PLMN in which the UE 3 needs to stay. The Target PLMN ID may be or may include information identifying a PLMN to which the UE 3 needs to register or to perform a Registration Procedure. The Target PLMN ID may be or may include information identifying a PLMN in which the UE 3 needs to stay. The Target PLMN ID may be or may include information identifying a PLMN regarding the RVAS. The Target PLMN ID may indicate that a PLMN to which the UE 3 needs to register or to perform a Registration Procedure for the RVAS. The Target PLMN ID may indicate that a PLMN in which the UE 3 needs to stay for the RVAS. The Target PLMN ID may be or may include information identifying a PLMN to which the UE 3 needs to register or to perform a Registration Procedure for the RVAS. The Target PLMN ID may be or may include information identifying a PLMN in which the UE 3 needs to stay for the RVAS.

The Target PLMN ID may be managed in the UDM 75 together with the Segment information in a case where the PLMN, as indicated by the Target PLMN ID, may have multiple segments.

The Segment information can be used to route any NAS messages between the UE 3 and node(s) (e.g., AMF(s) in different PLMN, AMF(s) in PLMN 2).

The Segment information can be used to route any HTTP (Hyper Text Transfer Protocol) messages over the SBI between signalling control node(s) (e.g., an AMF, a PCF, an SMF, a NEF, an NWDAF etc.) spanning PLMNs (including e.g., PLMN 2).

The Target PLMN ID can be used to route any signalling messages (NAS message(s) and/or HTTP message(s) over any SBI) to signalling control node(s) (e.g., an AMF, a PCF, an SMF, a NEF, an NWDAF etc.) in the PLMN (e.g., PLMN 2) associated with the Segment information or indicated by the Target PLMN ID.

The combination of the Segment information and the Target PLMN ID can be used to route any signalling messages (e.g., NAS message(s) and HTTP message(s) over any SBI) to an associated signalling control node(s) (e.g., an AMF, a PCF, an SMF, a NEF, an NWDAF etc.) to the Segment (e.g., “X”) in the associated PLMN (e.g., PLMN 2).

In the FIG. 1, the Segment information which is set to “X” is indicated as the Segment=X and the Target PLMN ID which is set to PLMN 2 is indicated as the PLMN ID=PLMN 2 as examples. For example, “the Segment=X” may be expressed as the Segment which is set to “X”, the Segment information which is set to “X”, the Segment “X” etc.,

For example, the Segment information may be set to “X” and the Target PLMN ID may be set to PLMN 2.

The Segment information set to “X” may indicate the group of the subscriber(s) which are eligible to have a unique service(s) that are provided by PLMN 2 (e.g., a name of the group is “X”) or may indicate that the user indicated by the User ID or the UE 3 is included in the group “X”.

The Segment information set to “X” may indicate the area where the unique service(s) is provided (e.g., a name of the area is “X”) and may indicate that the user indicated by the User ID or the UE 3 is included in the area “X”.

The Segment information set to “X” may indicate the area where the unique service(s) is provided (e.g., a name of the area is “X”) and may indicate that the user indicated by the User ID or the UE 3 is the user (or the UE) in the area “X”.

The Segment information set to “X” may indicate the above-mentioned certain IMSI range (e.g., a name of the IMSI range is “X”) and may indicate that the user indicated by the User ID or the UE 3 is included in the IMSI range “X”.

The Segment information set to “X” may indicate a group of subscribers which are of certain priority level or of certain security level which subscribers can be steered to another PLMN (e.g. PLMN 2) in case the current PLMN is congested.

The Segment information set to “X” may indicate a group of subscribers which have a subscription to a certain network slice or network slices which qualifies them for a service from another PLMN, e.g. PLMN 2.

The Target PLMN ID set to PLMN 2 may indicate that target PLMN for the UE 3 is PLMN 2.

The Target PLMN ID set to PLMN 2 may indicate that the UE 3 needs to be registered to PLMN 2. The Target PLMN ID set to PLMN 2 may indicate that the UE 3 needs to register to PLMN 2 (e.g., for the RVAS).

The Target PLMN ID set to PLMN 2 may indicate that the UE 3 needs to perform a Registration Procedure for PLMN 2 (e.g., for the RVAS).

The Target PLMN ID set to PLMN 2 may indicate that the UE 3 needs to stay in PLMN 2 (e.g., for the RVAS).

The Segment information may indicate that the UE 3 belongs to or included in the Segment. The Segment support indication included in the Nudm_SDM_Get Request message may indicate that the AMF 7001 supports to receive the Segment information and/or the Target PLMN ID from the UDM 75.

The Segment support indication included in the Nudm_SDM_Get Request message may indicate that the AMF 7001 supports to receive the Nudm_SDM_Get Response message including the Segment information and/or the Target PLMN ID from the UDM 75.

For example, the AMF 7001 may send the Nudm_SDM_Get Request message to the UDM 75 in PLMN 1 including the Segment support indication in a case where the AMF 7001 receives at least one of the Segment support indication from the UE 3 and the Segment support information from the NG-RAN 5 and the AMF 7001 supports to receive the Segment information and/or the Target PLMN ID from the UDM 75.

For example, the AMF 7001 may send the Nudm_SDM_Get Request message to the UDM 75 in PLMN 1 including the Segment support indication in a case where the AMF 7001 receives at least one of the Segment support indication from the UE 3 and the Segment support information from the NG-RAN 5 and the AMF 7001 supports to receive the Nudm_SDM_Get Response message including the Segment information and/or the Target PLMN ID from the UDM 75.

Step 6. Upon reception of the Nudm_SDM_Get Response message in step 5, the AMF 7001 sends a Registration Reject message to the UE 3 including a Re-registration required indication, the Segment information and/or the Target PLMN ID that are received from the UDM 75. The Re-registration required indication indicates to the UE 3 that the UE 3 is requested to initiate new Registration Procedure with the received Segment information and/or Target PLMN ID taken into account. The Re-registration required indication may indicate to the UE 3 that the UE 3 is requested to initiate new Registration Procedure.

The Segment support indication included in the Nudm_SDM_Get Request message may indicate that the AMF 7001 supports to send at least one of the Re-registration required indication, the Segment information and the Target PLMN ID to the UE 3.

Steps 7 to 9. Upon reception of the Registration Reject message in step 6, the UE 3 recognizes that a new Registration Procedure needs to be initiated.

For example, the UE 3 may recognize that the new Registration Procedure for PLMN 2 needs to be initiated in a case where the UE 3 receives the Registration Reject message in step 6.
The UE 3 establishes the RRC connection in order to send a NAS message. For example, the UE 3 establishes an RRC connection in order to send a NAS message to the AMF 7002. For example, for establishing the RRC connection, in step 7, the UE 3 may send, to the NG-RAN 5, an RRC Setup Request message in order to establish the RRC connection.
For example, in step 8, the NG-RAN 5 may send an RRC Setup message to the UE 3. For example, in step 8, the NG-RAN 5 may send an RRC Setup message to the UE 3 in a case where the NG-RAN 5 receives the RRC Setup Request message from the UE 3.
For example, in step 9, the UE 3 may send an RRC Setup Complete message to the NG-RAN 5. For example, in step 9, the UE 3 may send an RRC Setup Complete message to the NG-RAN 5 in a case where the UE 3 receives the RRC Setup message from the NG-RAN 5.
For example, the RRC Setup Complete message in step 9 includes a nas-Container including a Registration Request message, a SelectedPLMN-Identity set to PLMN 2 and/or the Segment information set to “X”. In one example the SelectedPLMN-Identity is set, by the UE 3, to the value (e.g., PLMN 2) as received in step 6 in the Registration Reject message.
In one example the Segment information is set, by the UE 3, to the value (e.g., “X”) as received in step 6 in the Registration Reject message.

In one example, the SelectedPLMN-Identity in the RRC Setup Complete message may be set only to the PLMN 2 so that if the cell being connected with the UE 3 supports multiple SelectedPLMN-Identites, the NG-RAN 5 is forced to select only any AMF in the PLMN 2.

For example, the UE 3 may perform step 7 in the FIG. 1 in a case where the UE 3 receives the Registration Reject message in step 6.
For example, the UE 3 may perform step 7 in the FIG. 1 in a case where the UE 3 receives the Registration Reject message in step 6 even if the UE 3 does not send the Segment support indication in step 1. For example, the UE 3 may not send the Segment support indication in step 1.
For example, the Segment support indication in step 1 may indicate that the UE 3 supports to receive the Registration Reject message in step 6.
For example, the Segment support indication in step 1 may indicate that the UE 3 can understand at least one of the Re-registration required indication, the Segment information and the Target PLMN ID in the Registration Reject message in step 6.
For example, the Segment support indication in step 1 may indicate that the UE 3 can understand at least one of the Re-registration required indication, the Segment information and the Target PLMN ID in the Registration Reject message in step 6 and can send the RRC Setup Request message.

For example, the Segment support indication in step 1 may indicate that the UE 3 can understand at least one of the Re-registration required indication, the Segment information and the Target PLMN ID in the Registration Reject message in step 6 and can send the RRC Setup Complete message including the nas-Container which includes at least one of the Registration Request message, the SelectedPLMN-Identity and the Segment information.

The Segment information which is set to “X” may indicate the Segment which is set to “X”. The Segment information which is set to “X” may indicate that the Segment is “X”.

Step 10. Upon reception of the RRC Setup Complete message from the UE 3, the NG-RAN 5 performs the AMF selection based on the received SelectedPLMN-Identity and/or Segment information. This NG-RAN 5 may consider a congestion on each candidate AMFs for selecting an AMF during the AMF selection. This AMF selection may be expressed as an AMF (re-)selection function based on the Segment information, an AMF (re-)selection based on the Segment information etc.,

“The NG-RAN 5 supports the AMF (re-)selection function based on the Segment information” may mean that the NG-RAN 5 is able to perform the AMF selection based on the received SelectedPLMN-Identity and/or Segment information.

For example, the NG-RAN 5 may store information indicating a relationship between PLMN(s) and AMF(s).

For example, the NG-RAN 5 may store information indicating a relationship between the Segment and AMF(s).
For example, the NG-RAN 5 may store information indicating a relationship among PLMN(s), AMF(s) and the Segment.
For example, the NG-RAN 5 may store information indicating available AMF(s) for the Segment (e.g., the Segment “X”).
For example, the NG-RAN 5 may store information indicating available AMF(s) in PLMN 2.
For example, the NG-RAN 5 may store information indicating available AMF(s) for the Segment (e.g., the Segment “X”) in PLMN 2.
For example, the NG-RAN 5 may store information indicating AMF(s) associated with the Segment (e.g., the Segment “X”).
For example, the NG-RAN 5 may store information indicating AMF(s) associated with PLMN 2.
For example, the NG-RAN 5 may store information indicating AMF(s) associated with the Segment (e.g., the Segment “X”) and PLMN 2.

For example, it assumes that the NG-RAN 5 may store information indicating that PLMN 2 is associated with an AMF 7002 (or indicating that the AMF 7002 is available in PLMN 2). In this case, the NG-RAN 5 may select or find the AMF 7002 which is associated with PLMN 2 indicated by the received SelectedPLMN-Identity.

For example, it assumes that the NG-RAN 5 may store information indicating that the AMF 7002 is associated with or is available for the Segment set to “X” The Segment set to “X” may mean the Segment information which is set to “X”, or may mean that a name of the Segment is “X” etc., In this case, the NG-RAN 5 may select or find the AMF 7002 which is associated with the received Segment information set to “X”. For example, the NG-RAN 5 may determine that the UE 3 is associated with the Segment set to “X” by using the Segment information which is set to “X”, and may select the AMF 7002 which is associated with the Segment set to “X”. The Segment information set to “X” may indicate the group of the subscriber(s) which are eligible to have the unique service(s) that are provided by PLMN 2, and indicate that a name of the group is “X”. The Segment information set to “X” may indicate the area where the unique service(s) are provided, and indicate that the area name is “X”.

For example, it assumes that the NG-RAN 5 may store information indicating that the AMF 7002 is associated with or is available for the above-mentioned certain IMSI range “X”. In this case, the NG-RAN 5 may select or find the AMF 7002 which is associated with the received Segment information set to “X” (or associated with the IMSI range “X”). The received Segment information set to “X” may indicate the IMSI range “X”.

For example, it assumes that the NG-RAN 5 may store information indicating that the Segment set to “X” in PLMN 2 is associated with an AMF 7002 (or indicating that the AMF 7002 is available for the Segment set to “X” in PLMN 2). In this case, the NG-RAN 5 may select or find the AMF 7002 which is associated with the Segment set to “X” in PLMN 2 indicated by the received SelectedPLMN-Identity and the received Segment information set to “X”. In this case, the Segment set to “X” may indicate the group of the subscriber(s) which are eligible to have the unique service(s) in PLMN 2, and indicate that a name of the group is “X”. In this case, the Segment set to “X” may indicate the area in PLMN 2 where the unique service(s) are provided, and indicate that the area name is =X″.

The AMF 7002 may be included in PLMN 2.

Step 11. Once the NG-RAN 5 finds (or selects) the AMF 7002 in PLMN 2 that the UE 3 needs to be associated with, the NG-RAN 5 sends a UE initial message (or an initial UE message) to the AMF 7002 including a nas-Container which includes the Registration Request message and the User ID with other information elements.

Step 12. The Registration procedure continues with step 4 in section 4.2.2.2.2 in 3GPP TS 23.502 [4]. For example, the AMF 7002 may perform the Registration procedure for the UE 3.

In this example, there may be some other examples which are not shown in the FIG. 1. Firstly, the NG-RAN 5 may provide PLMN 1 and PLMN 2 over the BCCH (e.g., in SIB1). The PLMN 1 may be provided in the first entry of a PLMN list and the PLMN 2 may be provided in the second entry of the same PLMN list, or vice versa. For example, the NG-RAN 5 may provide, over the BCCH, the PLMN list which includes the first entry of the list which is set to PLMN 1 and the second entry of the list which is set to PLMN 2. Alternatively, the NG-RAN 5 may provide the PLMN 1 and the PLMN 2 in separate PLMN lists over the BCCH (e.g., in SIB1). The same may be applied for other examples referring to the FIG. 1. Secondly, upon reception of the Registration Reject message at step 6, the NAS layer of the UE 3 informs (or sends), to the AS layer of the UE 3, the selected PLMN Identity information set to the PLMN 2 and the Segment information set to PLMN 2. Then, the AS layer (e.g., RRC layer) starts the RRC connection setup procedure as explained above for the Step 7. For example, in a case where the UE 3 receives the SIB 1 including PLMN 1 and PLMN 2 (e.g., by the PLMN list or the separate PLMN lists) and the UE 3 also receives the Registration Reject message including the Re-registration required indication, the Segment information and/or the Target PLMN ID which is set to PLMN 2 (e.g., in a case where the UE 3 recognizes that PLMN 2 indicated by the Target PLMN ID is available on the area where the UE 3 locates by referring to the PLMN list(s) on BCCH), the UE 3 may perform the process in step 7.

### Variant 1 of First Example of the First Aspect:

If the Nudm_UECM_Registration Request message in step 2 includes the Segment support indication, the Nudm_SDM_Get Request message in step 4 may not include the Segment support indication. The UDM 75 may consider that UE 3, NG-RAN 5 and AMF 7001 support the AMF (re-)selection function based on the Segment information as far as the UDM 75 receives the Segment support indication by the Nudm_UECM_Registration Request message and/or the Nudm_SDM_Get Request message.

### Variant 2 of First Example of the First Aspect:

When the AMF 7001 receives the Nudm_SDM_Get Response message which includes only the Segment information in step 5, the AMF 7001 may convert the received Segment information to a Target PLMN ID. For example, the AMF 7001 may store information to perform this conversion (e.g., the AMF 7001 may store information indicating that the Segment information which is set to “X” is associated with PLMN 2. In this case, the AMF 7001 may obtain the Target PLMN ID which is set to PLMN 2 based on the Segment information). Then, the AMF 7001 may send the Registration Reject message to the UE 3 including the Re-registration required indication, the Segment information and/or the Target PLMN ID in step 6.

### Variant 3 of First Example of the First Aspect:

In another example, at step 5 of the FIG. 1 the AMF 7001 may store the Segment information for the UE 3 which is retrieved from the UDM 75 and the AMF 7001 may store the Segment information in the UE 3's UE context within the AMF 7001. Then, at eventual UE 3 mobility within the PLMN 1, the AMF 7001 may transfer the UE 3's Segment information as part of the UE 3's context to the target AMF of PLMN 1 via an Namf_Communication_UEContextTransfer service operation in mobility re-registration or via an Namf_Communication_N1N2MessageTransfer service operation in N2 handover. The target AMF of PLMN 1 may use the so transferred Segment information for the UE 3 for further steering the UE 3 as per step 6 to 12 in the FIG. 1.

### Variant 4 of First Example of the First Aspect:

In one example, instead of sending the Registration Reject message, the AMF 7001 may send a Registration Accept message including the same contents to the Registration Reject message in step 6. After receiving the Registration Accept message including the Re-registration required indication, the Segment information and/or the Target PLMN ID, the UE 3 may send Registration complete message to the AMF 7001. After sending the Registration complete message, the UE 3 may select a cell of PLMN 2 and may perform a Registration Procedure to PLMN 2. For example, in a case where the UE 3 sends the Registration complete message, the UE 3 may perform the process in step 7 for PLMN 2.

### Variant 5 of First Example of the First Aspect:

In one example, in step 2 or 4, or in any message sent from the AMF to the UDM during the Registration Procedure, the AMF 7001 may indicate its capability that the AMF 7001 supports handling of sending the Re-registration required indication and/or the Segment information to the UE 3 and/or handling the procedure related to it. The UDM 75, in step 4, may include the Target PLMN ID and/or the Segment information to only the AMF (e.g., the AMF 7001) which indicated the capability. The capability may be the above-mentioned Segment support indication regarding the AMF 7001.

### Second Example of the First Aspect:

This aspect includes a mechanism to (re-) select an AMF 7002 based on UE 3's subscription data update in a UDM 75.

The AMF (re-)selection is performed by an NG-RAN 5 based on Segment information and/or a PLMN ID.

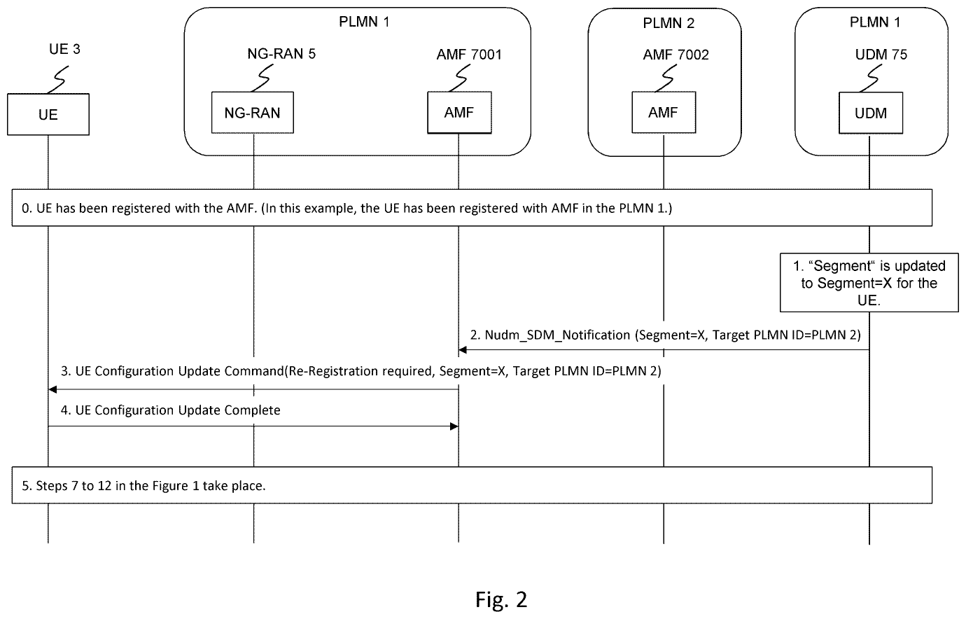

### FIG. 2: UE Configuration Update Procedure Due to Subscription Update

The detailed processes of the Second example of the First Aspect are described below with reference to the FIG. 2.

Step 0. As an example, the UE 3 has been registered with an AMF 7001 in PLMN 1.

Step 1. The Segment information, for example which indicate Segment “X” or which is set to “X”, is added or modified for the UE 3 in the UDM 75. In addition, the Target PLMN ID, for example which indicate PLMN 2 or which is set to PLMN 2, is added or modified for the UE 3 in the UDM 75.

For example, the UDM 75 may update subscription data for the UE 3 by adding or modifying the Segment information and/or the Target PLMN ID for the UE 3. For example, the UDM 75 may add the Segment information which is set to “X” to the subscription data for the UE 3.

For example, the UDM 75 may modify old Segment information in the subscription data for the UE 3 to new Segment information which is set to “X”.

For example, the UDM 75 may add the Target PLMN ID which is set to PLMN 2 to the subscription data for the UE 3.

For example, the UDM 75 may modify an old Target PLMN ID in the subscription data for the UE 3 to a new Target PLMN ID which is set to PLMN 2.

Definition of the Segment information of the First example of the First Aspect may be applied to the Second example of the First Aspect.

Definition of the Target PLMN ID of the First example of the First Aspect may be applied to the Second example of the First Aspect.

Step 2. The UDM 75 sends an Nudm_SDM_Notification message to the AMF 7001 including Subscriber Data. The Subscriber Data in Nudm_SDM_Notification message includes the Segment information and/or the Target PLMN ID. The Segment information and/or the Target PLMN ID are newly added in step 1 or updated or modified in step 1.

For example, in a case where the UDM 75 adds or updates or modifies the Segment information and/or the Target PLMN ID in step 1, the UDM 75 may send the Nudm_SDM_Notification message to the AMF 7001.
It may refer to the First example of the First Aspect for detail of the Segment information and/or the Target PLMN ID.

Step 3. Upon reception of the Nudm_SDM_Notification message in step 2, the AMF 7001 sends a UE Configuration Update Command message to the UE 3 including the Re-registration required indication, the Segment information and/or the Target PLMN ID which are received from the UDM 75.

It may refer to First example of the First Aspect for the details of the Re-registration required indication.

Step 4. Upon reception of the UE Configuration Update Command message from the AMF 7001, the UE 3 sends a UE Configuration Update Complete message to the AMF 7001.

Step 5. Steps 7 to 12 in the FIG. 1 of the First example of the First Aspect take place after step 4.

### Variant 1 of Second Example of the First Aspect:

When the AMF 7001 receives the Nudm_SDM_Notification message including the Segment information and/or the Target PLMN ID, the AMF 7001 may confirm whether the AMF 7001 itself is considered as a suitable AMF for providing a unique service(s), for example, a Roaming Value Added Service (RVAS) associated with the received Segment information and/or Target PLMN ID. If so (e.g., in a case where the AMF 7001 confirms that the AMF 7001 is considered as the suitable AMF for providing the unique service(s)), the AMF 7001 may not send the UE Configuration Update Command message to the UE 3 in step 3. I.e., the AMF 7001 may terminate this procedure.

For example, the AMF 7001 may store information for confirming whether the AMF 7001 itself is considered as the suitable AMF for providing the unique service(s).

For example, the AMF 7001 may store information indicating that the AMF 7001 is available for PLMN 2. In a case where the AMF 7001 receives the Target PLMN ID which is set to PLMN 2 from the UDM 75, the AMF 7001 may consider, based on the stored information, that the AMF 7001 itself is considered as the suitable AMF for providing the unique service(s).

For example, the AMF 7001 may store information indicating that the AMF 7001 is included in or is available for the Segment set to “X”. In a case where the AMF 7001 receives the Segment information which is set to “X” from the UDM 75, the AMF 7001 may consider, based on the stored information, that the AMF 7001 itself is considered as the suitable AMF for providing the unique service(s).

### Variant 2 of Second Example of the First Aspect:

In one example, at step 2 of the FIG. 2 the UE 3 may be in idle mode, i.e., no signalling connection available between the AMF 7001 and the UE 3. In this case the AMF 7001 may page the UE 3 and after establishing a signalling connection with the UE 3, the AMF 7001 may send the UE Configuration Update Command message at step 3, and the procedure continues as per steps 4 and 5 of the FIG. 2.

Alternatively, the AMF 7001 may first wait for the UE 3 to connect back to the network (e.g., for accessing a service) and then while there is a signalling connect between the UE 3 and AMF 7001, the AMF 7001 may send the UE Configuration Update Command message to the UE 3 and the procedure continues as per steps 4 and 5 of the FIG. 2.

### Third Example of the First Aspect:

This example includes a capability negotiation between a NG-RAN 5 and an AMF 7001.

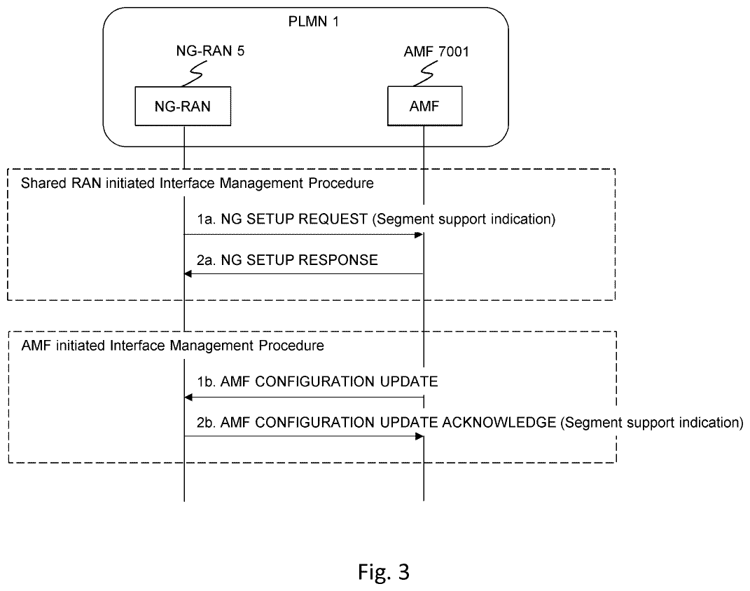

### FIG. 3: The Capability Negotiation Between the NG-RAN and the AMF

The detailed processes of the Third example of the First Aspect are described below with reference to the FIG. 3.

Steps 1a and 2a illustrate an NG-RAN initiated Interface management procedure and these steps may be independent from steps 1b and 2b.

Step 1a. The NG-RAN 5 sends an NG SETUP REQUEST message to the AMF 7001 including a Segment support indication. The Segment support indication indicates to the AMF 7001 that the NG-RAN 5 supports the AMF (re-)selection function based on the Segment information. The Segment support indication from the NG-RAN 5 may be used by the AMF 7001 when the AMF 7001 performs the Registration procedure as disclosed by the First example of the First Aspect and Second Example of the First Aspect in this disclosure.

For example, in a case where the AMF 7001 receives the Segment support indication from the NG-RAN 5, the AMF 7001 may determine that the NG-RAN 5 supports the AMF (re-)selection function based on the Segment information.

The Segment support indication included in the NG SETUP REQUEST message may indicate that the NG-RAN 5 supports to receive the Segment information and/or the Target PLMN ID (or the SelectedPLMN-Identity which is set to PLMN 2) from the UE 3.

The Segment support indication included in the NG SETUP REQUEST message may indicate that the NG-RAN 5 supports to receive the RRC Setup Complete message including the Segment information and/or the Target PLMN ID (or the SelectedPLMN-Identity which is set to PLMN 2) from the UE 3.

The Segment support indication included in the NG SETUP REQUEST message may indicate that the NG-RAN 5 supports to select an AMF (e.g., an AMF (e.g., the AMF 7002) in a PLMN (e.g., PLMN 2) other than a PLMN of the NG-RAN 5 (e.g., PLMN 1)) based on the Segment information (e.g., the Segment information which is set to “X”) and/or the Target PLMN ID (or the SelectedPLMN-Identity which is set to PLMN 2). The SelectedPLMN-Identity which is set to PLMN 2 may mean that the SelectedPLMN-Identity which is set to a PLMN other than a PLMN of the NG-RAN 5.

For example, the Segment support indication in the NG SETUP REQUEST message may indicate that the NG-RAN 5 can understand at least one of the SelectedPLMN-Identity which is set to PLMN 2 and the Segment information.

For example, the Segment support indication in the NG SETUP REQUEST message may indicate that the NG-RAN 5 can understand at least one of the SelectedPLMN-Identity which is set to PLMN 2 and the Segment information and can select the AMF based on at least one of the SelectedPLMN-Identity which is set to PLMN 2 and the Segment information. For example, the Segment support indication in the NG SETUP REQUEST message may indicate that the NG-RAN 5 can understand at least one of the SelectedPLMN-Identity which is set to PLMN 2 and the Segment information and can select the AMF based on at least one of the SelectedPLMN-Identity which is set to PLMN 2 and the Segment information, and can send the Initial UE message to the selected AMF.

The Segment support indication included in the NG SETUP REQUEST message may indicate that the NG-RAN 5 supports to or is able to perform at least one of steps 9 to 11 in the FIG. 1.

Step 2a. Upon reception of the NG SETUP REQUEST message in step 1a, the AMF 7001 stores the Segment support indication that is received in step 1a as a capability of the NG-RAN 5 and sends an NG SETUP RESPONSE message to the NG-RAN 5.

For example, steps 1a and 2a may be performed before processes in the FIG. 1. For example, steps 1a and 2a may be performed before step 1, 2 or 4 in the FIG. 1.

Steps 1b and 2b illustrate an AMF initiated Interface management procedure and these steps may be independent from steps 1a and 2a.

Step 1b. The AMF 7001 sends an AMF CONFIGURATION UPDATE message to the NG-RAN 5.

Step 2b. The NG-RAN 5 sends an AMF CONFIGURATION UPDATE message to the AMF 7001 including the Segment support indication. It may refer to step 2a for detail of the Segment support indication.

For example, in a case where the AMF 7001 receives the Segment support indication from the NG-RAN 5, the AMF 7001 may determine that the NG-RAN 5 supports the AMF (re-)selection function based on the Segment information.

For example, steps 1b and 2b may be performed before processes in the FIG. 1.

For example, steps 1b and 2b may be performed before step 1, 2 or 4 in the FIG. 1.

### Variant 1 of Third Example of the First Aspect:

Step 1a can be replaced with a RAN CONFIGURATION UPDATE message. Similarly, step 2a can be replaced with a RAN CONFIGURATION UPDATE ACKNOWLEDGE message.

### Variant 2 of Third Example of the First Aspect:

In one example, the AMF 7001 may provide its Segment support capability indication (e.g., the Segment support indication regarding the AMF 7001) to the NG-RAN 5 within a CN Assistance information parameter in an N2 message.

### Fourth Example of the First Aspect:

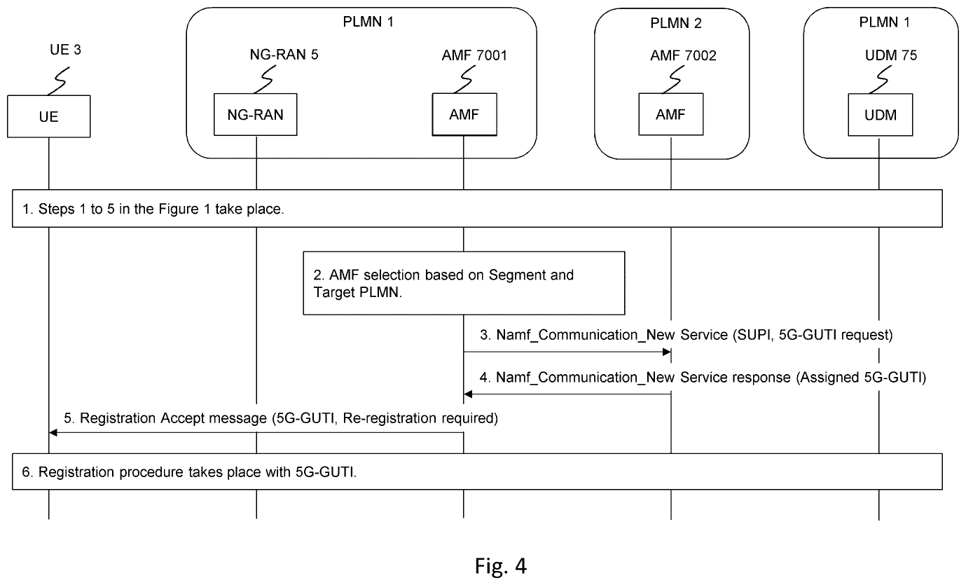

The FIG. 4 includes an example of the AMF (re-)selection by an AMF 7001 based on the segment and/or PLMN ID.

FIG. 4: AMF (Re-)Selection by the AMF Based on the Segment and/or PLMN ID

The detailed processes of the Fourth example of the First Aspect are described below with reference to the FIG. 4.

Step 1. The Registration procedure in steps 1 to 5 in the FIG. 1 for the First example of the First Aspect may take place.

Step 2. Upon reception of the Nudm_SDM_Get Response message from the UDM 75 including the Segment information and/or the Target PLMN ID, the AMF 7001 performs the AMF selection based on the received Segment information and/or Target PLMN ID.

For example, in a case where the AMF 7001 receives the Registration Request message from the NG-RAN 5 in step 1, the AMF 7001 may send the Nudm_UECM_Registration Request message to the UDM 75 in the same manner as step 2 of the FIG. 1. Then, upon reception of the Nudm_UECM_Registration Request message, the UDM 75 may send the Nudm_UECM_Registration Response message to the AMF 7001 in the same manner as step 3 of the FIG. 1. Then, the AMF 7001 may send the Nudm_SDM_Get Request message to the UDM 75 in the same manner as step 4 of the FIG. 1. Upon reception of the Nudm_SDM_Get Request message, the UDM 75 may send the Nudm_SDM_Get Response message in the same manner as step 5 of the FIG. 1.

Upon reception of the Nudm_SDM_Get Response message from the UDM 75 including the Segment information and/or the Target PLMN ID, the AMF 7001 performs the AMF selection based on the received Segment information and/or Target PLMN ID.

For example, the AMF 7001 may perform the AMF selection in the same manner as the AMF selection by the NG-RAN 5 in step 10 of the FIG. 1. For example, the AMF 7001 may store the information to perform the AMF selection in the same manner as the NG-RAN 5.

For example, the AMF 7001 may select or choose an AMF 7002 in the AMF selection.

Step 3. Once the AMF 7001 chooses the AMF 7002 (e.g., once the AMF 7001 chooses the AMF 7002 as the target AMF for AMF re-location), the AMF 7001 sends an Namf_Communication_NewService message to the AMF 7002 including SUPI (e.g., SUPI of the UE 3) and 5G-GUTI request. The 5G-GUTI request may indicate that the AMF 7001 requests the AMF 7002 to issue or assign a 5G-GUTI to the UE 3. The 5G-GUTI request may indicate that the AMF 7001 requests the AMF 7002 to issue or assign a 5G-GUTI to the UE 3 as indicated in the SUPI.

Step 4. Upon reception of the Namf_Communication_NewService message from the AMF 7001, the AMF 7002 assigns the 5G-GUTI to the UE 3. For example, the AMF 7002 assigns the 5G-GUTI to the UE 3 as indicated by the SUPI. The AMF 7002 sends an Namf_Communication_NewService response message to the AMF 7001 including Assigned 5G-GUTI (e.g., the 5G-GUTI assigned by the AMF 7002).

Step 5. Upon reception of the Namf_Communication_NewService response message from the AMF 7002, the AMF 7001 sends a Registration Accept message to the UE 3 including 5G-GUTI set with the Assigned 5G-GUTI and Re-registration required indication. The Re-registration required indication indicates the UE 3 that the UE 3 is requested to initiate new Registration Procedure with the received 5G-GUTI. For example, the AMF 7001 may send the Registration Accept message including the Assigned 5G-GUTI and the Re-registration required indication.

Step 6. The UE 3 initiates the Registration Procedure as described in 3GPP TS 23.502 [4] with the received 5G-GUTI. As the 5G-GUTI is assigned by the AMF 7002, the Registration procedure can be performed with the AMF 7002.

For example, in a case where the UE 3 receives the Re-registration required indication, the UE 3 may initiate the Registration Procedure by using the received 5G-GUTI.

For example, in a case where the UE 3 receives the Re-registration required indication, the UE 3 may determine that the new Registration Procedure using the received 5G-GUTI is requested. Then the UE 3 may initiate the new Registration procedure by using the received 5G-GUTI.

For example, in a case where the UE 3 initiates the new Registration procedure by using the received 5G-GUTI, the UE 3 may send a Registration Request message to the AMF 7002 via the NG-RAN 5 or an NG-RAN in PLMN 2.

### Variant 1 of Fourth Example of the First Aspect:

Step 3 can be replaced with a UEContextTransfer message, a CreateUEContext message, a RelocateUEContext message or existing or new AMF service messages.

Similarly, step 4 can be replaced with a UEContextTransfer response message, a CreateUEContext response message, a RelocateUEContext response message or existing or new AMF service response messages.

### Variant 2 of Fourth Example of the First Aspect:

Step 5 can be replaced with a Registration Reject message, a DL NAS transfer message or any existing or new NAS messages.

### Variant 3 of Fourth Example of the First Aspect:

In step 2, the AMF 7001 may interrogate with an NSSF, a PCF or an OAM system to find a Target AMF (e.g., the AMF 7002). In this case, the AMF 7001 may send a message to the NSSF, PCF or OAM system including the Segment information and/or Target PLMN ID and User ID. As the response, the NSSF, the PCF or the OAM system may send a reply message including the Target AMF (e.g., information indicating the AMF 7002).

For example, at least one of the NSSF, the PCF and the OAM system may be configured to find the Target AMF. For example, at least one of the NSSF, the PCF and the OAM system may store information indicating AMF(s) corresponding to at least one of the Segment information, the Target PLMN ID and the User ID. Based on the stored information, at least one of the NSSF, the PCF and the OAM system may find the Target AMF. For example, in the same manner as the NG-RAN 5 in step 10 of the FIG. 1, at least one of the NSSF, the PCF and the OAM system may find or select the Target AMF.

### Variant 4 of Fourth Example of the First Aspect:

In one example, in step 3, the AMF 7001 may include, in the Namf_communication_Newservice message, Requested NSSAI as received from the UE 3 in the Registration Request message. Upon reception of the Namf_communication_Newservice message, the AMF 7002 may find a third AMF which can handle the Requested NSSAI. For example, the AMF 7002 may store information to find the third AMF (e.g., information indicating that the Requested NSSAI (e.g. S-NSSAI(s) in the Requested NSSAI) can be handled by the third AMF), and may find the third AMF based on the stored information. For example, the AMF 7002 may find the third AMF in a case where the AMF 7002 itself is not able to handle the Requested NSSAI (e.g., S-NSSAI(s) in the Requested NSSAI).

Then the AMF 7002 may pass a GUAMI of the third AMF to the AMF 7001 in step 4. The AMF 7001 may include the received GUAMI into the Registration Accept message. For example, the AMF 7001 may set the received GUAMI in step 4 to a GUAMI of the 5G-GUTI to be sent to the UE 3, and may send the Registration Accept message including the 5G-GUTI which includes the received GUAMI in step 4. The third AMF may be included in PLMN 2.

Upon reception of the Registration Accept message, the UE 3 may select a PLMN (e.g., PLMN 2) by using MCC and MNC set in the received GUAMI. The UE 3 further may include the GUAMI in the RRC Setup Complete message when performing the Registration procedure to PLMN 2. The NG-RAN 5 will use this GUAMI to select the third AMF. Then the Registration procedure with the third AMF may continue.

### Fifth Example of the First Aspect:

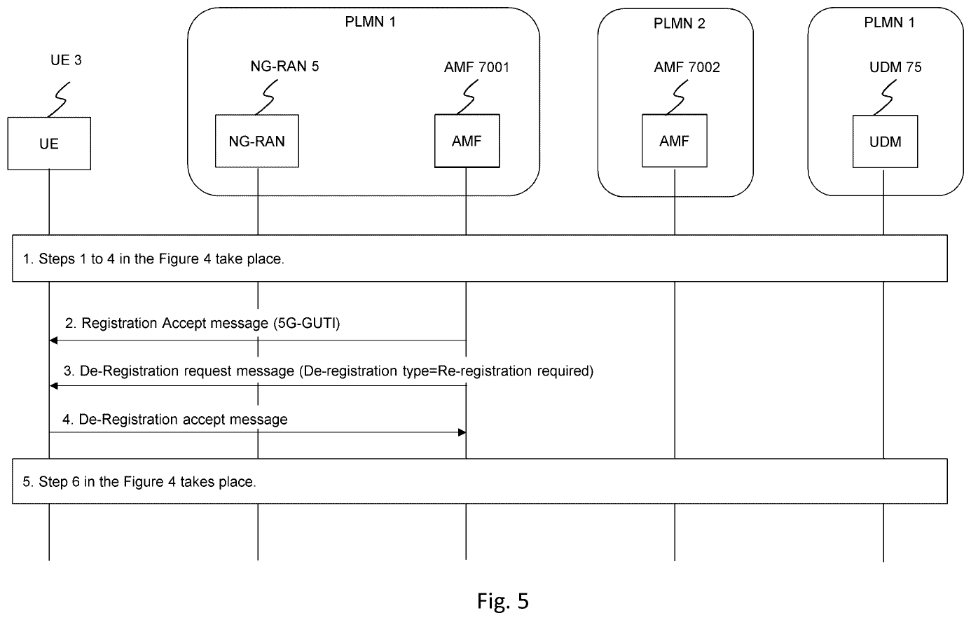

The FIG. 5 includes an example of the AMF (re-)selection by an AMF 7001 based on the Segment information and/or PLMN ID. This example may work with any of UE(s) 3 that are compliant with the 3GPP Release 18 or older releases. FIG. 5: AMF (re-)selection by the AMF based on the segment and/or PLMN ID The detailed processes of the Fifth example of the First Aspect are described below with reference to the FIG. 5.

Step 1. The Registration procedure in steps 1 to 4 in the FIG. 4 for the Fourth example of the First Aspect take place.

Step 2. Upon reception of the Namf_Communication_NewService response message from the AMF 7002, the AMF 7001 sends a Registration Accept message to the UE 3 including 5G-GUTI.

For example, in a case where the AMF 7001 receives the 5G-GUTI (e.g., the 5G-GUTI which is set to the Assigned 5G-GUTI) from the AMF 7002, the AMF 7001 may send the Registration Accept message to the UE 3 including the 5G-GUTI.

Step 3. Right after (or after) the AMF 7001 sends the Registration Accept message to the UE 3 in step 2, the AMF 7001 sends a De-Registration request message to the UE 3 including De-registration type set to Re-registration required. The De-registration type set to Re-registration required may indicate the UE 3 that the UE 3 is requested to initiate new Registration Procedure with the received 5G-GUTI (e.g., the 5G-GUTI which is sent to the UE 3 in step 2).

Step 4. The UE 3 sends the De-Registration accept message to the AMF 7001. Step 5. Step 6 in the FIG. 4 for the Fourth Example of the First Aspect takes place. For example, in a case where the UE 3 receives the De-Registration request message including the De-registration type set to Re-registration required, the UE 3 may initiate the Registration Procedure by using the received 5G-GUTI.

For example, in a case where the UE 3 receives the De-Registration request message including the De-registration type set to Re-registration required, the UE 3 may determine that the new Registration Procedure using the received 5G-GUTI is requested. Then the UE 3 may initiate the new Registration procedure by using the received 5G-GUTI.

For example, the UE 3 may perform the new Registration procedure for PLMN 2 by using the received 5G-GUTI.

For example, the UE 3 may perform the new Registration procedure with the AMF 7002 by using the received 5G-GUTI.

### Sixth Example of the First Aspect:

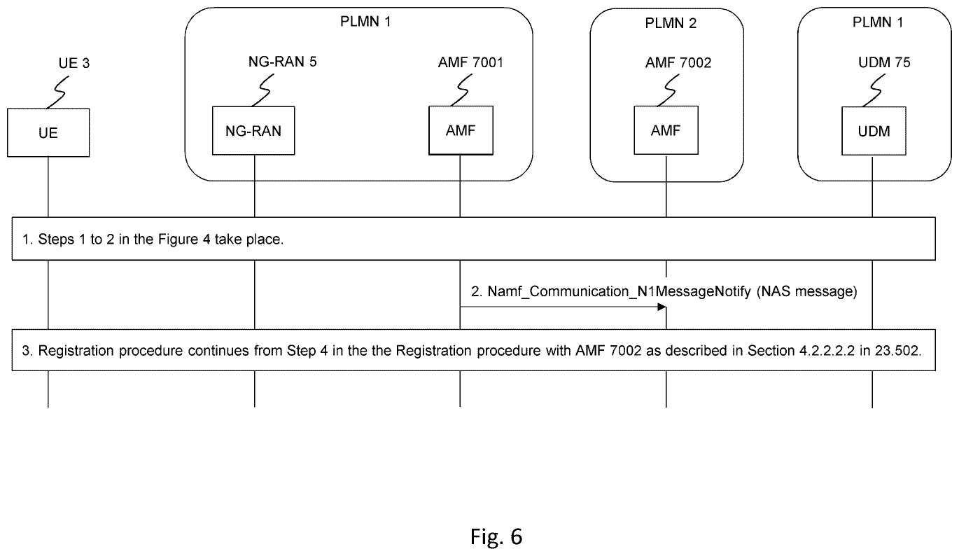

The FIG. 6 includes an example of the AMF (re-)selection by an AMF 7001 based on the Segment information and/or PLMN ID. This example may work with any of UE(s) 3 that are compliant with the 3GPP Release 18 or older releases.

FIG. 6: AMF (Re-)Selection by the AMF Based on the Segment and/or PLMN ID
The detailed processes of the Sixth Example of the First Aspect are described below with reference to the FIG. 6.

Step 1. The Registration procedure in steps 1 to 2 in the FIG. 4 for the Fourth Example of the First Aspect take place.

Step 2. Once the AMF 7001 chooses the AMF 7002 (e.g., once the AMF 7001 selects the AMF 7002 as a target AMF to be re-allocated), the AMF 7001 sends an Namf_Communication_NIMessageNotify message including the NAS message received from the UE 3.

For example, the AMF 7001 may send the Namf_Communication_N1MessageNotify message to instruct the AMF 7002 to perform the Registration procedure for the UE 3.

The Namf_Communication_N1MessageNotify message may include information needed for performing the Registration procedure.

Step 3. The Registration procedure continues from step 4 in the Registration procedure as described in Section 4.2.2.2.2 in 3GPP TS 23.502 [4] with the AMF 7002. The Registration procedure may be performed via the NG-RAN 5 or an NG-RAN in PLMN 2.

For example, the AMF 7002 may perform the Registration procedure for the UE 3 in a case where the AMF 7002 receives the Namf_Communication_N1MessageNotify message.

For example, the AMF 7002 may perform the Registration procedure for the UE 3 in a case where the AMF 7002 receives the Namf_Communication_N1MessageNotify message to perform the Registration procedure.

### Seventh Example of the First Aspect:

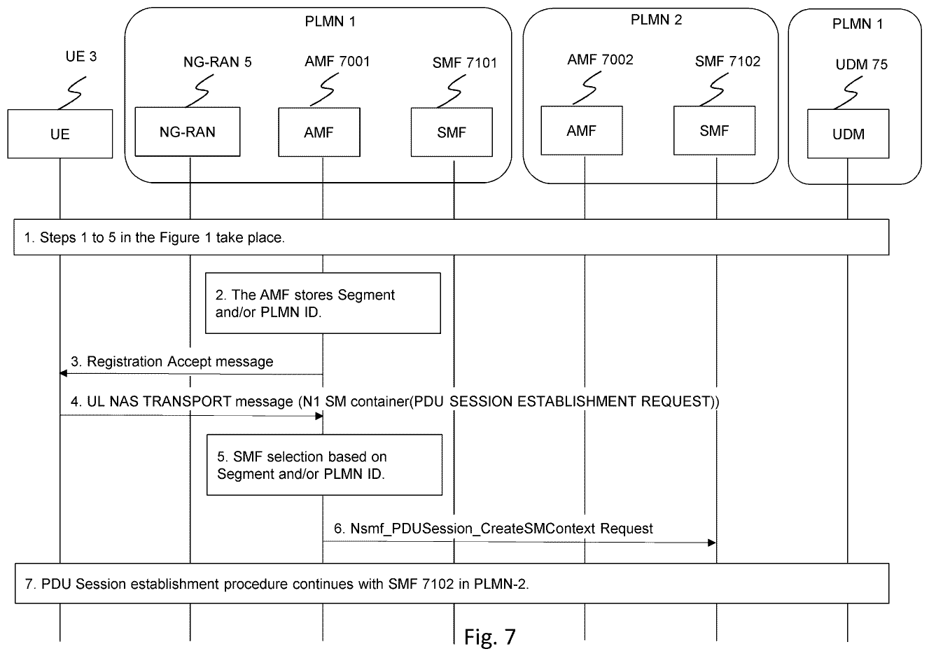

The FIG. 7 includes an example of the SMF selection by an AMF 7001 based on the Segment information related to UE 3 and/or PLMN ID.

In this example, a unique service, for example, the Roaming Value Added Service (RVAS) associated with the received Segment information and/or PLMN ID is provided by a PDU session established between a UE 3 and PLMN 2.

This example may work with any of UE(s) 3 that are compliant with the 3GPP Release 18 or older releases.

FIG. 7: PDU Session Establishment Procedure with PLMN 2

The detailed processes of the Seventh example of the First Aspect are described below with reference to the FIG. 7.

Step 1. The Registration procedure in steps 1 to 5 in the FIG. 1 for the First Example of the First Aspect take place.

Step 2. Upon reception of the Nudm_SDM_Get Response message from the UDM 75 including the Segment information and/or Target PLMN ID, the AMF 7001 stores the received Segment information and/or Target PLMN ID in the UE context for the UE 3 in the AMF 7001.

Step 3. The AMF 7001 sends a Registration Accept message to the UE 3.

Step 4. After the successful registration with the AMF 7001 in PLMN 1, the UE 3 sends a UL NAS TRANSPORT message to the AMF 7001 including N1 SM container which contains PDU SESSION ESTABLISHMENT REQUEST (e.g., a PDU session establishment request message). The UL NAS TRANSPORT message may include a Request type.

For example, the UE 3 may send the UL NAS TRANSPORT message to establish a PDU session. The UL NAS TRANSPORT message may include a PDU session establishment request message.

The Request type which may be set to initial request, existing PDU session, initial emergency request, existing emergency PDU session, modification request or MA PDU request. The PDU session establishment request message is sent by the UE 3 as the UE 3 requests the Roaming Value Added Service (RVAS) associated with the Segment information and/or Target PLMN ID provided by the PDU session established between a UE 3 and PLMN 2.

The Request type may be set to PDU SESSION ESTABLISHMENT REQUEST.

The Request type which is set to PDU SESSION ESTABLISHMENT REQUEST may indicate that the AMF 7001 is requested to perform a SMF selection explained in following step 5.

The Request type which is set to PDU SESSION ESTABLISHMENT REQUEST may indicate to the AMF 7001 that a SMF selection explained in following step 5 is needed.

The Request type which is set to PDU SESSION ESTABLISHMENT REQUEST may indicate that the UE 3 requests establishment of a PDU session.

For example, in a case where the UE 3 sends the Segment support indication in step 1, the UE 3 may send the UL NAS TRANSPORT message including the Request type which is set to PDU SESSION ESTABLISHMENT REQUEST.

Step 5. Upon reception of the UL NAS TRANSPORT message or upon reception of the UL NAS TRANSPORT message including the Request type which is set to PDU SESSION ESTABLISHMENT REQUEST, the AMF 7001 selects an SMF 7102 based on the stored Segment information and/or Target PLMN ID in the UE context for the UE 3.

For example, the AMF 7001 may store information indicating a relationship between PLMN(s) and SMF(s).

For example, the AMF 7001 may store information indicating a relationship between the Segment and SMF(s).

For example, the AMF 7001 may store information indicating a relationship among PLMN(s), SMF(s) and the Segment.

For example, the AMF 7001 may store information indicating available SMF(s) for the Segment (e.g., the Segment “X”).

For example, the AMF 7001 may store information indicating available SMF(s) in PLMN 2.

For example, the AMF 7001 may store information indicating SMF(s) associated with the Segment (e.g., the Segment “X”).

For example, the AMF 7001 may store information indicating SMF(s) associated with PLMN 2. For example, it assumes that the AMF 7001 may store information indicating that PLMN 2 is associated with an SMF 7102 (or indicating that the SMF 7102 is available in PLMN 2). In this case, the AMF 7001 may select or find the SMF 7102 which is associated with PLMN 2 indicated by the stored Target PLMN ID.

For example, it assumes that the AMF 7001 may store information indicating that the SMF 7102 is associated with or is available for the Segment set to “X”. The Segment set to “X” may mean the Segment information which is set to “X”, or may mean that a name of the Segment is “X” etc., In this case, the AMF 7001 may select or find the SMF 7102 which is associated with the stored Segment information set to “X” For example, the AMF 7001 may determine that the UE 3 is associated with the Segment set to “X” by using the stored Segment information which is set to “X”, and may select the SMF 7102 which is associated with the Segment set to “X”. The Segment information set to “X” may indicate the group of the subscriber(s) which are eligible to have the unique service(s) that are provided by PLMN 2, and indicate that a name of the group is “X”. The Segment set to “X” may indicate the area where the unique service(s) are provided, and indicate that the area name is “X”.

For example, it assumes that the AMF 7001 may store information indicating that the SMF 7102 is associated with or is available for the above-mentioned certain IMSI range “X”. In this case, the AMF 7001 may select or find the SMF 7102 which is associated with the stored Segment information set to “X” (or associated with the IMSI range “X”). The stored Segment information set to “X” may indicate the IMSI range “X”.

For example, it assumes that the AMF 7001 may store information indicating that the Segment set to “X” in PLMN 2 is associated with an SMF 7102 (or indicating that the SMF 7102 is available for the Segment set to “X” in PLMN 2). In this case, the AMF 7001 may select or find the SMF 7102 which is associated with the Segment set to “X” in PLMN 2 indicated by the stored Target PLMN ID and the stored Segment information set to “X”. In this case, the Segment set to “X” may indicate the group of the subscriber(s) which are eligible to have the unique service(s) in PLMN 2, and indicate that a name of the group is “X”. In this case, the Segment set to “X” may indicate the area in PLMN 2 where the unique service(s) are provided, and indicate that the area name is “X”. The SMF 7102 may be included in PLMN 2.

For example, the AMF 7001 may perform the above-mentioned SMF selection for the UE 3 in a case where the AMF 7001 receives the UL NAS TRANSPORT message from the UE 3.

For example, in a case where the AMF 7001 receives the UL NAS TRANSPORT message from the UE 3, the AMF 7001 may check the Segment information and/or the Target PLMN ID in the UE context for the UE 3 in the AMF 7001. Then the AMF 7001 may find the appropriate SMF (e.g., SMF 7102) for the UE 3 based on the Segment information and/or the Target PLMN ID in the UE context for the UE 3. For example, the UL NAS TRANSPORT message may include information identifying the UE 3. For example, in a case where the AMF 7001 receives the information identifying the UE 3, the AMF 7001 may check the Segment information and/or the Target PLMN ID in the UE context for the UE 3 in the AMF 7001.

Step 6. Once the SMF 7102 is selected, the AMF 7001 sends an Nsmf_PDUSession_CreateSMContext Request message to the SMF 7102 in PLMN 2.

For example, the AMF 7001 may send the Nsmf_PDUSession_CreateSMContext Request message to establish the PDU session.

Step 7. The PDU Session establishment procedure continues with step 4 in the Section 4.3.2.2.1 in 3GPP TS 23.502 [4] with the SMF 7102 in PLMN 2.

For example, in a case where the SMF 7102 receives the Nsmf_PDUSession_CreateSMContext Request message, the SMF 7102 may perform the PDU Session establishment procedure to establish the PDU session for the UE 3.

### Variant 1 of the Seventh Example of the First Aspect:

In a case where the UE 3 sends a Service Request message after step 3, the AMF 7001 may send an Nsmf_PDUSession_UpdateSMContext Request message to the SMF 7102. Then, the Service Request procedure continues with step 5b in section 4.2.3.2 in 3GPP TS 23.502 [4].

For example, in a case where the AMF 7001 receives the Service Request message from the UE 3 and the AMF 7001 selects the SMF 7102 in the same manner as step 5 in the FIG. 7, the AMF 7001 may send the Nsmf_PDUSession_UpdateSMContext Request message to the SMF 7102.

### Variant 2 of the Seventh Example of the First Aspect:

In a case where the UE 3 is removed from Segment “X”, the UDM 75 sends an update message to the AMF 7001 (e.g., an Nudm_SDM_Notification message), informing the AMF 7001 of change(s) in the user profile (e.g., the Subscriber Data for the UE 3). The update message may also contain an additional indication on the update of the user profile, for example, time lag of X seconds/minutes (e.g., “X” may be a number greater than 0). If there are established PDU session(s) that are associated with the Segment “X” when the AMF 7001 receives the update message indicating the removal from Segment “X” from the UDM 75 (e.g., the update message indicating that the UE 3 is removed from Segment “X”), the AMF 7001 may initiate the PDU Session Release procedure as described in 3GPP TS 23.502 [4] for all established PDU session(s) that are associated with the Segment “X”.

Alternatively, the UDM 75 can send an update message to the SMF 7101 (e.g., an Nudm_SDM_Notification message), which may trigger the SMF 7101 to modify all PDU sessions associated with the Segment “X”, according to the procedure described in 3GPP TS 23.502 [4].

### Eighth Example of the First Aspect:

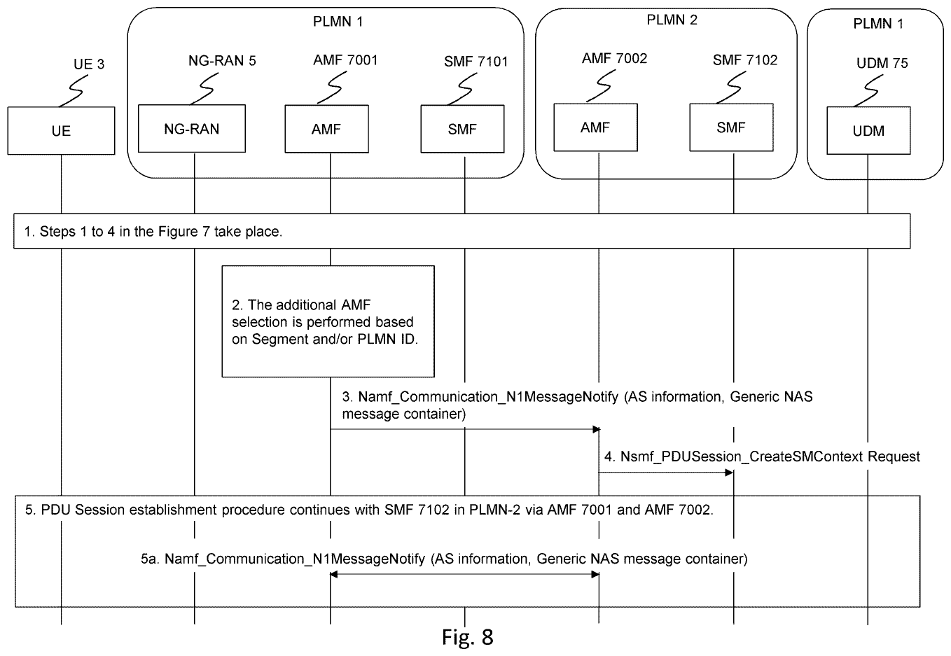

The FIG. 8 includes an example of the AMF addition by an AMF 7001 based on the Segment information related to a UE 3 and/or PLMN ID.

In this example, a unique service, for example, the Roaming Value Added Service (RVAS) associated with the received Segment information and/or PLMN ID is provided by a PDU session established between a UE 3 and PLMN 2. This example may work with any of UE(s) 3 that are compliant with the 3GPP Release 18 or older releases.

FIG. 8: PDU Session Establishment Procedure with PLMN 2 with AMFs in PLMN 1 and PLMM 2

The detailed processes of the Eighth example of the First Aspect are described below with reference to the FIG. 8.

Step 1. Steps 1 to 4 in the FIG. 7 for the Seventh example of the First Aspect take place.

Step 2. Upon reception of the UL NAS TRANSPORT message or upon reception of the UL NAS TRANSPORT message including the Request type which is set to PDU SESSION ESTABLISHMENT REQUEST, the AMF 7001 selects the AMF 7002 based on the stored Segment information and/or Target PLMN ID in the UE context for the UE 3.

For example, the AMF 7001 may perform the AMF selection in the same manner as step 2 in the FIG. 4.
For example, the AMF 7001 may select the AMF 7002 in the same manner as step 2 in the FIG. 4.

Step 3. The AMF 7001 sends an Namf_Communication_NIMessageNotify message to the selected AMF 7002 including AS information and Generic NAS message container. The Generic NAS message container contains the NAS message that is received from the UE 3.

For example, the Generic NAS message container may contain the NAS message that is received from the UE 3 in at least one of step 1 of the FIG. 1 and step 4 of the FIG. 7.

For example, the Generic NAS message container may contain at least one content or information of the NAS message that is received from the UE 3 in at least one of step 1 of the FIG. 1 and step 4 of the FIG. 7.

The NAS message in step 1 of the FIG. 1 may be the Registration Request message. The NAS message in step 4 of the FIG. 7 may be the UL NAS TRANSPORT message.

The Namf_Communication_N1MessageNotify message may include information or a message(s) related to the PDU session (e.g., the PDU session establishment request message).

The Generic NAS message container may include information or a message(s) related to the PDU session (e.g., the PDU session establishment request message).

For example, the AMF 7001 may send the Namf_Communication_NIMessageNotify message to establish the PDU session.

Step 4. Upon reception of the Namf_Communication_NlMessageNotify message from the AMF 7001, the AMF 7002 sends an Nsmf_PDUSession_CreateSMContext Request message to the SMF 7102 in PLMN 2.

For example, the AMF 7002 may send the Nsmf_PDUSession_CreateSMContext Request message in the same manner as step 6 of the FIG. 7.

Step 5. The PDU Session establishment procedure continues with step 4 in the Section 4.3.2.2.1 in 3GPP TS 23.502 [4] with the SMF 7102 in PLMN 2. For example, the AMF 7002 may perform the PDU Session establishment procedure in the same manner as step 7 of the FIG. 7.

For example, in step 5, the below step 5a may be performed.

Step 5a includes a process how the AMF 7001 in PLMN 1 and the AMF 7002 in PLMN 2 communicate during the PDU Session establishment procedure.

If the AMF 7001 receives the NAS message from the UE 3 related to the PDU session (e.g., in a case where the AMF 7001 receives the NAS message related to the PDU session (e.g., the NAS message mentioned in step 3) from the UE 3, or in a case where the AMF 7001 receives, from the UE 3, the NAS message that is mentioned in at least one of step 1 of the FIG. 1 and step 4 of the FIG. 7), the AMF 7001 sends an Namf_Communication_NIMessageNotify message to the AMF 7002 including AS information and Generic NAS message container. The Generic NAS message container sent by the AMF 7001 contains the NAS message that is received from the UE 3.

If the AMF 7002 receives any Nsmf service messages or Namf service messages from the SMF 7102 containing an N1 SM container intending to be sent to the UE 3, the AMF 7002 sends an Namf_Communication_NIMessageNotify message to the AMF 7001 including AS information and Generic NAS message container. The Generic NAS message container sent by the AMF 7002 contains an N1 SM container that is received from the SMF 7102.

### Variant 1 of the Eighth Example of the First Aspect:

In a case where the UE 3 sends a Service Request message after the step 5, the received NAS message handling and the received N1 SM container handling between the AMF 7001 and the AMF 7002 are the same as message handling as described in step 5a.

According to at least one of the First Aspect and the variants in the First Aspect, it can solve the above-mentioned problem.

For example, at least one of the First Aspect and the variants in the First Aspect can solve the problem that according to the latest 3GPP mobility management functionalities, the AMF in the HPLMN of the UE cannot be relocated to another AMF from a PLMN which is different from the HPLMN of the UE.

For example, at least one of the First Aspect and the variants in the First Aspect can solve the problem that the latest 3GPP specification(s) may not meet the new service requirement.

For example, according to at least one of the First Aspect and the variants of the First Aspect, the NG-RAN 5 in PLMN 1 or the AMF 7001 in PLMN 1 can select the AMF 7002 in PLMN 2 which is different from the AMF 7001 in PLMN 1 (e.g., the HPLMN of the UE 3) based on the Segment information and/or the Target PLMN ID. That is, the AMF 7001 in PLMN 1 (which corresponds to the AMF in the HPLMN) can be relocated to the AMF 7002 in PLMN 2 (which corresponds to another AMF from the PLMN which is different from the HPLMN). In addition, for example, the UE 3 can perform the Registration procedure for the AMF 7002. Therefore, it can solve the above-mentioned problem.

For example, according to at least one of the First Aspect and the variants of the First Aspect, the AMF 7001 in PLMN 1 can select the AMF 7002 in PLMN 2 or the SMF 7102 in PLMN 2, and can communicate with the AMF 7002 or the SMF 7102 to establish the PDU session(s) (e.g., the PDU session(s) for the RVAS). Therefore, it can solve the above-mentioned problem.

### Second Aspect

For example, this Aspect includes mechanisms that can solve the above-mentioned problem (e.g., the identified problem outlined as the Operational problem in the Problem Statement).

### First Example of the Second Aspect:

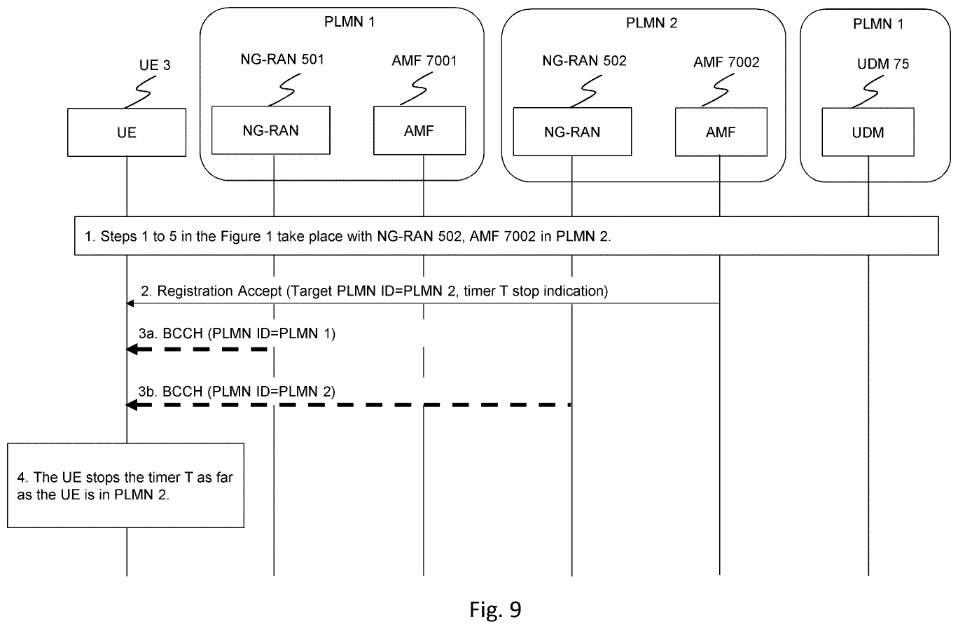

The FIG. 9 includes an example of the UE behaviour for staying in cell(s) that broadcasts a PLMN ID other than a PLMN ID of the UE 3's HPLMN based on Target PLMN ID from an AMF 7001 related to the UE 3.

### FIG. 9: UE Retains Cells in PLMN 2 by Stopping Timer T

The detailed processes of the First example of the Second Aspect are described below with reference to the FIG. 9. For example, an NG-RAN 501 in PLMN 1 may be same to or may have same function(s) to the NG-RAN 5 in the FIG. 1.

Step 1. Steps 1 to 5 in the FIG. 1 for the First example of the First Aspect may take place. For example, in the same manner as steps 1 to 5 in the FIG. 1 for the First example of the First Aspect, the processes for the UE 3, an NG-RAN 502 in PLMN 2, an AMF 7002 in PLMN 2, the UDM 75 in PLMN 1 (or an UDM in PLMN 2) may take place.

For example, the UE 3 may send the Registration Request message to the AMF 7002 in the same manner as step 1 of the FIG. 1. Contents of the Registration Request message sent to the AMF 7002 may be same to the contents of the Registration Request message in step 1 of the FIG. 1.

For example, upon reception of the Registration Request message from the UE 3, the AMF 7002 may send an Nudm_UECM_Registration Request message to the UDM 75 in the same manner as step 2 of the FIG. 1.

For example, upon reception of the Registration Request message from the UE 3, the AMF 7002 may send an Nudm_UECM_Registration Request message to a UDM in PLMN 2 in the same manner as step 2 of the FIG. 1.

Contents of the Nudm_UECM_Registration Request message sent to the UDM 75 or the UDM in PLMN 2 may be same to the contents of the Nudm_UECM_Registration Request message in step 2 of the FIG. 1.

For example, the UDM 75 may store not only information regarding PLMN 1 (e.g., Subscriber Data for UE(s) in PLMN 1) but also information regarding PLMN 2 (e.g., Subscriber Data for UE(s) in PLMN 2). In a case where the UDM 75 store not only information regarding PLMN 1 (e.g., Subscriber Data for UE(s) in PLMN 1) but also information regarding PLMN 2 (e.g., Subscriber Data for UE(s) in PLMN 2), the AMF 7002 may send the Nudm_UECM_Registration Request message to the UDM 75. For example, the UDM 75 may be used by both node(s) in PLMN 1 and node(s) in PLMN 2 commonly.

For example, the UDM 75 may store at least one of information regarding PLMN 1 (e.g., Subscriber Data for UE(s) in PLMN 1) and information regarding PLMN 2 (e.g., Subscriber Data for UE(s) in PLMN 2).

For example, the UDM in PLMN 2 may store at least one of information regarding PLMN 1 (e.g., Subscriber Data for UE(s) in PLMN 1) and information regarding PLMN 2 (e.g., Subscriber Data for UE(s) in PLMN 2).

For example, upon reception of the Nudm_UECM_Registration Request message, the UDM 75 or the UDM in PLMN 2 may send an Nudm_UECM_Registration Response message to the AMF 7002 in the same manner as step 3 of the FIG. 1.

For example, the AMF 7002 may send an Nudm_SDM_Get Request message to the UDM 75 or the UDM in PLMN 2 including the Segment support indication in a case where at least one of the UE 3, the NG-RAN 502 and the AMF 7002 support the AMF (re-)selection function based on the Segment information in the same manner as step 4 of the FIG. 1. Contents of the Nudm_SDM_Get Request message sent to the UDM 75 or the UDM in PLMN 2 may be same to the contents of the Nudm_SDM_Get Request message in step 4 of the FIG. 1.

The Segment support indication included in the Nudm_SDM_Get Request message may indicate that at least one of the UE 3, the NG-RAN 502 and the AMF 7002 support the AMF (re-)selection function based on the Segment information.

For example, the AMF 7002 may determine that the UE 3 supports the AMF (re-)selection function based on the Segment information in the same manner to the First Aspect. For example, the AMF 7002 may determine whether the NG-RAN 502 supports the AMF (re-)selection function based on the Segment information in the same manner to the First Aspect.

For example, the AMF 7002 may determine that the AMF 7002 itself supports the AMF (re-)selection function based on the Segment information in the same manner to the First Aspect.

For example, upon reception of the Nudm_SDM_Get Request message, the UDM 75 or the UDM in PLMN 2 may send an Nudm_SDM_Get Response message to the AMF 7002 in the same manner as step 5 of the FIG. 1. Contents of the Nudm_SDM_Get Response message sent to the AMF 7002 may be same to the contents of the Nudm_SDM_Get Response message in step 5 of the FIG. 1.

The process(es) performed by the AMF 7001 in steps 1 to 5 in the FIG. 1 may be replaced with the process(es) performed by the AMF 7002 in the Second Aspect respectively.

The process(es) performed by the UDM 75 in steps 2 to 5 in the FIG. 1 may be replaced with the process(es) performed by the UDM 75 or the UDM in PLMN 2 in the Second Aspect respectively.

The information regarding the AMF 7001 which is communicated between the AMF 7001 and the UDM 75 in steps 2 to 5 in the FIG. 1 may be replaced with information regarding the AMF 7002 in the Second Aspect respectively. The information regarding the AMF 7002 may be communicated between the AMF 7002 and the UDM 75 (or the UDM in PLMN 2).

The message(s) and information regarding the nodes (e.g., an AMF(s), an NG-RAN(s), a UDM(s), a UE(s)) in the First Aspect may be replaced with message(s) and information regarding the nodes (e.g., an AMF(s), an NG-RAN(s), a UDM(s), a UE(s)) in the Second Aspect.

Step 2. The AMF 7002 sends a Registration Accept message to the UE 3 including timer T stop indication, Segment information and/or Target PLMN ID. The timer T stop indication indicates to the UE 3 that as far as the UE 3 is in a PLMN as indicated by the Target PLMN ID, the UE 3 is forced to stop the timer T. The timer T is defined in section 4.4.3.3.1.1 in 3GPP TS 23. 122 [7].

For example, the Segment information may be set to “X” and the Target PLMN ID may be set to PLMN 2.
For example, in a case where the timer T expires, the UE 3 may attempt to select or may attempt to go back (or return) to an HPLMN (e.g., PLMN 1). For example, in a case where the timer T expires, the UE 3 may attempt to obtain service(s) on the HPLMN (e.g., PLMN 1).

For example, in a case where the AMF 7002 receives the Nudm_SDM_Get Response message, the AMF 7002 may send the Registration Accept message. The Segment information in the Second Aspect may be same to the Segment information in the First Aspect. A definition of the Segment information in the First Aspect may be applied to the Second Aspect.

The Target PLMN ID in the Second Aspect may be same to the Target PLMN ID in the First Aspect. A definition of the Target PLMN ID in the First Aspect may be applied to the Second Aspect. For example, the Target PLMN ID may be set to PLMN 2.

For example, the timer T stop indication may indicate to the UE 3 that as far as the UE 3 is in PLMN 2 indicated by the Target PLMN ID, the UE 3 is forced to stop the timer T.

For example, in a case where the Registration Accept message includes the Target PLMN ID which is set to PLMN 2 and the timer T stop indication, the timer T stop indication may indicate to the UE 3 that as far as the UE 3 is in PLMN 2 indicated by the Target PLMN ID, the UE 3 is forced to stop the timer T.

Step 3a. Cell(s) that are connected to the NG-RAN 501 broadcast its PLMN ID which is set to PLMN 1.

Note that the broadcasting message in step 3a may be constantly broadcasted by the cell(s) that are connected to the NG-RAN 501. The PLMN ID may be broadcasted over BCCH (e.g., SIB1).
For example, the PLMN ID which is set to PLMN 1 may be included in the SIB 1. For example, the NG-RAN 501 may broadcast the SIB 1. For example, the NG-RAN 501 may broadcast the SIB 1 on the cell(s) that are connected to the NG-RAN 501. For example, the UE 3 may determine or consider that the UE 3 is in PLMN 1 (or that the UE 3 is in cell(s) of PLMN 1) in a case where the UE 3 receives or scans the PLMN ID which is set to PLMN 1.

Step 3b. Cell(s) that are connected to the NG-RAN 502 broadcast its PLMN ID which is set to PLMN 2.

Note that the broadcasting message in step 3b may be constantly broadcasted by the cell(s) that are connected to the NG-RAN 502.

For example, the PLMN ID which is set to PLMN 2 may be included in the SIB 1. For example, the NG-RAN 502 may broadcast the SIB 1. For example, the NG-RAN 502 may broadcast the SIB 1 on the cell(s) that are connected to the NG-RAN 502. For example, the UE 3 may determine or consider that the UE 3 is in PLMN 2 (or that the UE 3 is in cell(s) of PLMN 2) in a case where the UE 3 receives or scans the PLMN ID which is set to PLMN 2.

Step 4. The UE 3 stops the timer T as far as the UE 3 is in cell(s) for PLMN 2. Stopping timer T prevents the UE 3 from moving to other cell(s) of other PLMN, including cell(s) for PLMN 1, so that the UE 3 can stay in the cell(s) for PLMN 2.

The stopping timer T may be interpreted as one of followings:
The UE 3 stops the timer T. For example, the UE 3 may stop the timer T in case where the timer T is running, and may stay in PLMN 2.
The UE 3 ignores expiration of the timer T. For example, the UE 3 may ignore the expiration of the timer T, and may stay in PLMN 2 even if the timer T expires.
The UE 3 overrides the timer T in the SIM (or in the USIM) in the UE 3 with no periodic attempts. For example, the UE 3 may stop the timer T or may stop a function of the timer T. In addition, the UE 3 may configure the function of the timer T so that the UE 3 does not attempt to go back to an HPLMN (e.g., PLMN 1) periodically.

For example, the timer T stop indication may instruct or indicate to the UE 3 to perform at least one of the stopping the timer T, the ignoring expiration of the timer T and the overriding the timer T.

For example, the timer T stop indication may instruct or indicate to the UE 3 to stay in PLMN 2 (e.g., cell(s) in PLMN 2) by performing at least one of the stopping the timer T, the ignoring expiration of the timer T and the overriding the timer T.

For example, the timer T stop indication may instruct or indicate to the UE 3 to stay in PLMN 2 (e.g., cell(s) in PLMN 2).

For example, the timer T stop indication may instruct or indicate to the UE 3 to stay in a PLMN indicated by the Target PLMN ID (e.g., PLMN 2).

For example, the timer T stop indication may instruct or indicate to the UE 3 to stay in cell(s) of a PLMN indicated by the Target PLMN ID (e.g., cell(s) in PLMN 2).

For example, in a case where the UE 3 performs at least one of the stopping the timer T, ignoring the expiration of the timer T and overriding the timer T, the UE 3 may stay in the cell(s) for PLMN 2 (or the UE 3 can stay in the cell(s) for PLMN 2 or the UE 3 may keep staying in the cell(s) for PLMN 2).

The cell(s) for PLMN 1 may be expressed as the cell(s) that are connected to the NG-RAN 501.
The cell(s) for PLMN 2 may be expressed as the cell(s) that are connected to the NG-RAN 502.

For example, in a case where the UE 3 receives (or listens to) the broadcasted PLMN ID which is set to PLMN 1, the UE 3 may determine that the UE 3 is in the cell(s) for PLMN 1.

For example, in a case where the UE 3 receives (or listens to) the broadcasted PLMN ID which is set to PLMN 2, the UE 3 may determine that the UE 3 is in the cell(s) for PLMN 2.

For example, in a case where the UE 3 receives (or listens to) both the broadcasted PLMN ID which is set to PLMN 1 and the broadcasted PLMN ID which is set to PLMN 2, the UE 3 may determine that the UE 3 is in both the cell(s) for PLMN 1 and the cell(s) for PLMN 2.

For example, in a case where the UE 3 receives the broadcasted PLMN ID which is set to PLMN 2, the UE 3 may stay in the cell(s) for PLMN 2 (or the UE 3 can stay in the cell(s) for PLMN 2 or the UE 3 may keep staying in the cell(s) for PLMN 2).

For example, in a case where the UE 3 receives the Registration Accept message including the Target PLMN ID which is set to PLMN 2 and the timer T stop indication and the UE 3 receives the broadcasted PLMN ID which is set to PLMN 2, the UE 3 may stay in the cell(s) for PLMN 2 (or the UE 3 can stay in the cell(s) for PLMN 2 or the UE 3 may keep staying in the cell(s) for PLMN 2).

For example, in a case where the UE 3 receives the Registration Accept message including the Target PLMN ID which is set to PLMN 2 and the timer T stop indication and the UE 3 receives the broadcasted PLMN ID which is set to PLMN 2, the UE 3 may stop the timer T (or may ignore the expiration (or expiry) of the timer T or may override the timer T), and may stay in the cell(s) for PLMN 2 (or the UE 3 can stay in the cell(s) for PLMN 2 or the UE 3 may keep staying in the cell(s) for PLMN 2).

For example, in a case where the UE 3 receives the Registration Accept message including the Target PLMN ID which is set to PLMN 2 and the timer T stop indication and the UE 3 receives the broadcasted PLMN ID which is set to PLMN 2, the UE 3 may stop the timer T (or may ignore the expiration (or expiry) of the timer T or may override the timer T), and may stay in the cell(s) for PLMN 2 (or the UE 3 can stay in the cell(s) for PLMN 2 or the UE 3 may keep staying in the cell(s) for PLMN 2), even if the UE 3 receives (or listens to) the broadcasted PLMN ID which is set to PLMN 1.

When the UE 3 cannot find any cells broadcasting the PLMN ID which is set to PLMN 2 (e.g., in a case where the UE 3 cannot find any cells broadcasting the PLMN ID which is set to the Target PLMN ID received in the Registration Accept message in step 2 or the UE 3 cannot receive the PLMN ID which is set to the Target PLMN ID received in the Registration Accept message in step 2), the UE 3 removes (or deletes) the timer T stop indication and uses a value of the timer T in the SIM (or in the USIM). Then the UE 3 may start the timer T which is set to the value.

When the UE 3 tunes to a cell in which the PLMN ID which is set to PLMN 2 (e.g., the PLMN ID which is set to the Target PLMN ID received in the Registration Accept message in step 2) is not being broadcasted, the UE 3 removes the timer T stop indication and uses a value of timer T in the SIM (or in the USIM). Then the UE 3 may start the timer T which is set to the value.

For example, in a case where the UE 3 receives the Target PLMN ID which is set to PLMN 2, the UE 3 may determine that the UE 3 keeps staying in PLMN 2 even if the UE 3 also is in PLMN 1 (e.g., even if the UE 3 can receive the PLMN ID which is set to PLMN 1).

### Variant 1 of First Example of the Second Aspect:

In step 2, the timer T stop indication can be replaced with another value.

For example, the timer T can be set to a value in the range 1 day to 40 days in 1-day steps. A long periodic network selection attempt may re-confirm the network configuration by the UE 3 while the UE 3 is in the PLMN 2, i.e., other than HPLMN.

### Second Example of the Second Aspect:

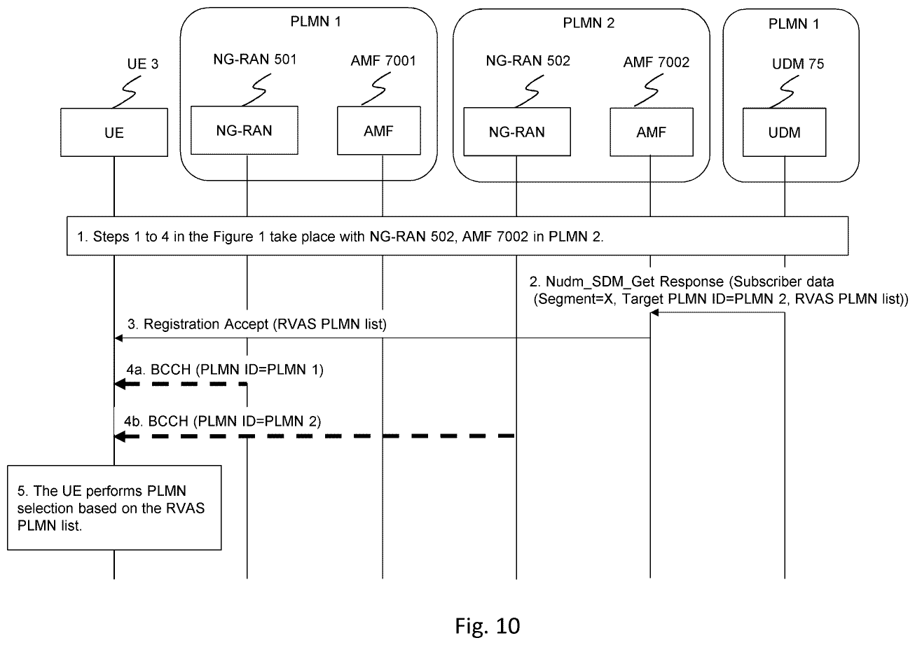

The FIG. 10 includes an example of the UE behaver for staying in cell(s) that broadcasts a PLMN ID other than a PLMN ID of the UE 3's HPLMN based on RVAS PLMN list.

FIG. 10: UE Retains Cells in PLMN 2 with RVAS PLMN List
The detailed processes of the Second example of the Second Aspect are described below with reference to the FIG. 10.

Step 1. Steps 1 to 4 in the FIG. 1 for the First example of the First Aspect may take place.

For example, the UE 3 may send the Registration Request message to an AMF 7002 in PLMN 2 in the same manner as step 1 of the FIG. 1. Contents of the Registration Request message sent to the AMF 7002 may be same to the contents of the Registration Request message in step 1 of the FIG. 1.

For example, upon reception of the Registration Request message from the UE 3, the AMF 7002 may send an Nudm_UECM_Registration Request message to the UDM 75 in the same manner as step 2 of the FIG. 1.

For example, upon reception of the Registration Request message from the UE 3, the AMF 7002 may send an Nudm_UECM_Registration Request message to a UDM in PLMN 2 in the same manner as step 2 of the FIG. 1.

Contents of the Nudm_UECM_Registration Request message sent to the UDM 75 or the UDM in PLMN 2 may be same to the contents of the Nudm_UECM_Registration Request message in step 2 of the FIG. 1.

For example, the UDM 75 may store not only information regarding PLMN 1 (e.g., Subscriber Data for UE(s) in PLMN 1) but also information regarding PLMN 2 (e.g., Subscriber Data for UE(s) in PLMN 2). In a case where the UDM 75 store not only information regarding PLMN 1 (e.g., Subscriber Data for UE(s) in PLMN 1) but also information regarding PLMN 2 (e.g., Subscriber Data for UE(s) in PLMN 2), the AMF 7002 may send the Nudm_UECM_Registration Request message to the UDM 75. For example, the UDM 75 may be used by both node(s) in PLMN 1 and node(s) in PLMN 2 commonly. For example, the UDM 75 may store at least one of information regarding PLMN 1 (e.g., Subscriber Data for UE(s) in PLMN 1) and information regarding PLMN 2 (e.g., Subscriber Data for UE(s) in PLMN 2). For example, the UDM in PLMN 2 may store at least one of information regarding PLMN 1 (e.g., Subscriber Data for UE(s) in PLMN 1) and information regarding PLMN 2 (e.g., Subscriber Data for UE(s) in PLMN 2).

For example, upon reception of the Nudm_UECM_Registration Request message, the UDM 75 or the UDM in PLMN 2 may send an Nudm_UECM_Registration Response message to the AMF 7002 in the same manner as step 3 of the FIG. 1.

For example, the AMF 7002 may send an Nudm_SDM_Get Request message to the UDM 75 or the UDM in PLMN 2 including the Segment support indication in a case where at least one of the UE 3, NG-RAN 502 and AMF 7002 support the AMF (re-)selection function based on the Segment information in the same manner as step 4 of the FIG. 1.

Contents of the Nudm_SDM_Get Request message sent to the UDM 75 or the UDM in PLMN 2 may be same to the contents of the Nudm_SDM_Get Request message in step 4 of the FIG. 1.
The Segment support indication included in the Nudm_SDM_Get Request message may indicate that at least one of the UE 3, the NG-RAN 502 and the AMF 7002 support the AMF (re-)selection function based on the Segment information.

For example, the AMF 7002 may determine that the UE 3 supports the AMF (re-)selection function based on the Segment information in the same manner to the First Aspect.

For example, the AMF 7002 may determine whether NG-RAN 502 supports the AMF (re-)selection function based on the Segment information in the same manner to the First Aspect.

For example, the AMF 7002 may determine that the AMF 7002 itself supports the AMF (re-)selection function based on the Segment information in the same manner to the First Aspect.

For example, without performing sending the Nudm_SDM_Get Response message, step 1 of the First example of the Second Aspect may be performed.

Step 2. The UDM 75 sends an Nudm_SDM_Get Response message including Subscriber Data. The Subscriber Data in the Nudm_SDM_Get Response message includes an RVAS PLMN list, a Segment information and/or a Target PLMN ID. The Segment information may be same to one in the First Aspect. The Target PLMN ID may be same to one in the First Aspect. The RVAS PLMN list indicates the preferred PLMN list for the UE 3 taking the RVAS into account. The RVAS PLMN list may indicate the preferred PLMN(s) for the UE 3 taking the RVAS into account. The RVAS PLMN list may include PLMN(s) to be selected by the UE 3 taking the RVAS into account. The RVAS PLMN list may include PLMN(s) related to the RVAS. For example, the RVAS PLMN list may include PLMN 2. If the UE 3 receives the RVAS PLMN list, the UE 3 may take one of the following actions:
the RVAS PLMN list takes precedence over an HPLMN list, an EHPLMN list, a preferred PLMN list, a Forbidden PLMN list and a network slice based PLMN list. For example, the UE 3 may use the RVAS PLMN list in preference to at least one of the EHPLMN list, the preferred PLMN list, the Forbidden PLMN list and the network slice based PLMN list.
the RVAS PLMN list takes precedence over the preferred PLMN list, the Forbidden PLMN list and the network slice based PLMN list. For example, the UE 3 may use the RVAS PLMN list in preference to at least one of the preferred PLMN list, the Forbidden PLMN list and the network slice based PLMN list.
the RVAS PLMN list takes precedence over the preferred PLMN list and the network slice based PLMN list. For example, the UE 3 may use the RVAS PLMN list in preference to at least one of the preferred PLMN list and the network slice based PLMN list.
the RVAS PLMN list takes precedence over the preferred PLMN list and the Forbidden PLMN list. For example, the UE 3 may use the RVAS PLMN list in preference to at least one of the preferred PLMN list and the Forbidden PLMN list.

It may refer to step 5 in the FIG. 1 for detail of the Segment information and the Target PLMN ID.

In the FIG. 10, the Segment information which is set to “X” is indicated as the Segment=X and the Target PLMN ID which is set to PLMN 2 is indicated as the PLMN ID=PLMN 2 as examples.

For example, the Segment information may be set to “X” and the Target PLMN ID may be set to PLMN 2.

Step 3. The AMF 7002 sends a Registration Accept message to the UE 3 including RVAS PLMN list. It may refer to step 2 how the UE 3 uses the RVAS PLMN list. The Registration Accept message may include the Segment information and/or the Target PLMN ID.

Step 4a. Cell(s) that are connected to the NG-RAN 501 broadcast its PLMN ID which is set to PLMN 1. For example, the NG-RAN 501 may broadcast or send the PLMN ID which is set to PLMN 1.

Note that the broadcasting message as illustrated in step 3a may be constantly broadcasted by the cell(s) that are connected to the NG-RAN 501.

Step 4b. Cells that are connected to the NG-RAN 502 broadcast its PLMN ID which is set to PLMN 2. For example, the NG-RAN 502 may broadcast or send the PLMN ID which is set to PLMN 2.

Note that the broadcasting message as illustrated in step 3b may be constantly broadcasted by the cell(s) that are connected to the NG-RAN 502.

Step 5. The NAS part of the UE 3 transfers the received RVAS PLMN list to the AS part of the UE 3.

The UE 3 stays in cell(s) for PLMN 2 according to the RVAS PLMN list in a case where PLMN 2 is listed as the highest preference or higher preference than any PLMNs that the UE 3 can scan.
For example, the UE 3 may stay in cell(s) for PLMN 2 in a case where PLMN 2 is listed in the RVAS PLMN list.

For example, the UE 3 may stay in cell(s) for PLMN 2 in a case where PLMN 2 is listed in the RVAS PLMN list and/or the UE 3 receives the PLMN ID which is set to PLMN 2 even if the UE 3 is in PLMN 1 (e.g., even if the UE 3 can receive the PLMN ID which is set to PLMN 1 and/or even if PLMN 1 is listed in the above-mentioned PLMN list other than the RVAS PLMN list).

### Third Example of the Second Aspect:

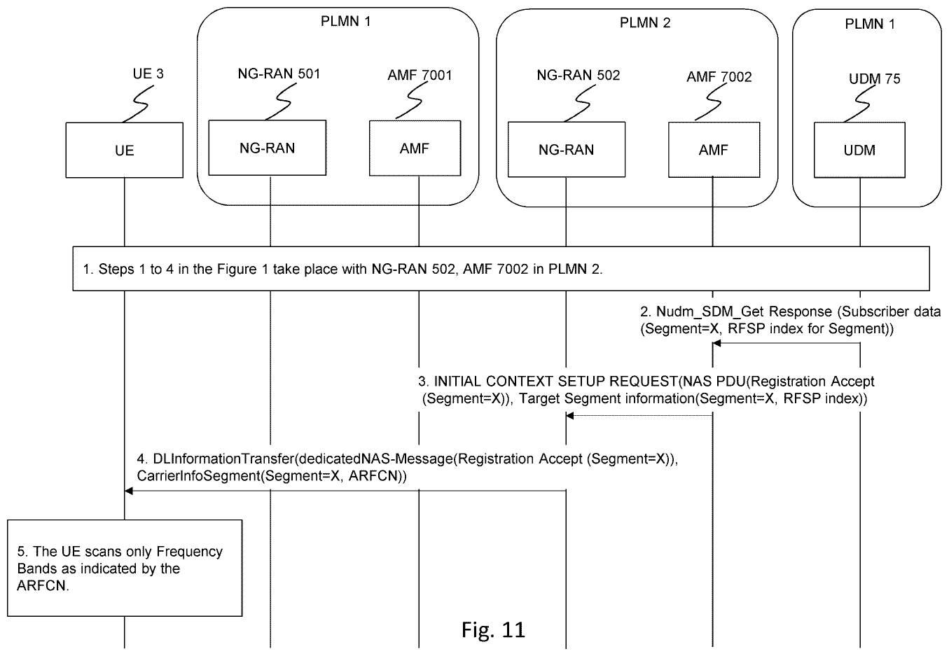

The FIG. 11 includes an example of the UE behaviour for staying in cell(s) that broadcasts a PLMN ID other than a PLMN ID of the UE 3's HPLMN by only scanning frequency band(s) that is indicated by an RRC message.

FIG. 11: UE Retains Cells in PLMN 2 with Limited ARFCN Scanning

The detailed processes of the Third example of the Second Aspect are described below with reference to the FIG. 11.

Step 1. Steps 1 to 4 in the FIG. 1 for the First example of the First Aspect may take place. Alternatively, step 1 in the FIG. 10 for the Second example of the Second Aspect may take place.

Step 2. The UDM 75 (or the UDM in PLMN 2) sends an Nudm_SDM_Get Response message with a Subscriber Data. The Subscriber Data in the Nudm_SDM_Get Response message includes the Segment information and RFSP index. The RFSP index is used for specific RRM strategies, taking into account any available information in RAN(s) that associates to the Segment information. The RFSP index is mapped by the RAN(s) to locally defined configuration to derive UE specific cell reselection priorities to control idle mode camping and to decide on redirecting active mode UE(s) to different frequency layers or RAT(s). The RFSP index may be associated with the Segment information. The RFSP index may be associated with ARFCN.

It may refer to step 5 in the FIG. 1 for detail of Segment information.

In the FIG. 11, the Segment information which is set to “X” is indicated as the Segment=X as examples. For example, the Segment information may be set to “X”.

Step 3. The AMF 7002 sends an INITIAL CONTEXT SETUP REQUEST message to the NG-RAN 502 including NAS PDU and Target Segment information. The NAS PDU includes a Registration Accept message. The Registration Accept message includes the Segment information which is set to “X”. The Target Segment information includes the combination of the Segment information which is set to “X” and the RFSP index. In one example, the Segment information may be associated with multiple RFSP indexes.

Step 4. The NG-RAN 502 sends a DLInformation Transfer message to the UE 3 including dedicatedNAS-Message and CarrierInfoSegment. The dedicatedNAS-Message includes the Registration Accept message. The Registration Accept message includes the Segment information which is set to “X”. The CarrierInfoSegment includes the combination of the Segment information which is set to “X” and ARFCN. In one example, the Segment information may be associated with multiple ARFCNs.

For example, the NG-RAN 502 may convert the received RFSP index to the ARFCN. For example, the NG-RAN 502 may store information to perform this conversion. For example, the NG-RAN 502 may store information indicating mapping the RFSP index and the ARFCN.

For example, based on the stored information, the NG-RAN 502 may convert the received RFSP index to the ARFCN.
For example, the CarrierInfoSegment may include only ARFCN(s). In this case, the UE 3 can associate the received CarrierInfoSegment in the RRC message (e.g., the DLInformation Transfer message) with the Segment information that is separately received in the NAS message (e.g., the Registration Accept message).

Step 5. Upon reception of the CarrierInfoSegment including the Segment information and the ARFCN, the UE 3 performs scanning or background scanning only the frequency band(s) that are indicated by the ARFCN in the RRC message (e.g., the DLInformation Transfer message) as far as the UE 3 is subscribed with the Segment=X (e.g., the Segment which is set to “X”).

For example, the UE 3 may perform scanning or background scanning only the frequency band(s) that are indicated by the ARFCN.

For example, the UE 3 may determine that the UE 3 is subscribed with the Segment which is set to “X” based on information in the SIM (or in the USIM) of the UE 3. For example, the SIM (or the USIM) may include information indicating that the UE 3 is subscribed with the Segment. For example, the UE 3 may determine that the UE 3 is subscribed with the Segment which is set to “X” in a case where the UE 3 determines that there is the information indicating that the UE 3 is subscribed with the Segment in the SIM (or in the USIM).

For example, the UE 3 may determine that the UE 3 is subscribed with the Segment which is set to “X” in a case where the UE 3 receives the Segment information which is set to “X” from the NG-RAN 502.

For example, the UE 3 may determine that the UE 3 is subscribed with the Segment which is set to “X” in a case where the UE 3 receives the DLInformationTransfer message including the Segment information which is set to “X”.
For example, the UE 3 may determine that the UE 3 is subscribed with the Segment which is set to “X” in a case where the UE 3 receives the DLInformationTransfer message including at least one of the Registration Accept message which includes the Segment information which is set to “X” and the CarrierInfoSegment which includes the Segment information which is set to “X”. For example, the UE 3 may perform the scanning or the background scanning only the frequency band(s) that are indicated by the ARFCN in the RRC message (e.g., the DLInformation Transfer message) in a case where the UE 3 is subscribed with the Segment which is set to “X”.

For example, the UE 3 may perform the scanning or the background scanning only the frequency band(s) that are indicated by the ARFCN in the RRC message (e.g., the DLInformation Transfer message) in a case where the UE 3 determines that the UE 3 is subscribed with the Segment which is set to “X”. For example, the UE 3 may scan only the frequency band(s) that are indicated by the ARFCN, therefore, it can reduce power consumption of the UE 3.

In a case where the UE 3 receives (or listens to) the broadcasted PLMN ID which is set to PLMN 2 on the frequency band(s) that are indicated by the ARFCN, the UE 3 may determine that the UE 3 is in the cell(s) for PLMN 2, may stay in the cell(s) for PLMN 2, and may stop the timer T in the same manner as the First example of the Second Aspect.

In addition, the mechanism may be applied to the Second example of the Second Aspect.
For example, in the Second example of the Second Aspect, the UE 3 may receive (or listens to) the broadcasted PLMN ID which is set to PLMN 2 on the frequency band(s) that are indicated by the ARFCN.

### Variant 1 of Third Example of the Second Aspect:

In step 4, the DLInformationTransfer message can be replaced with an RRCSetup message, an RRCReject message, an RRCRelease message, an RRCResume message, an RRCReconfiguration message, an RRCReestablishment message or any existing RRC message or a new RRC message.

### Fourth Example of the Second Aspect:

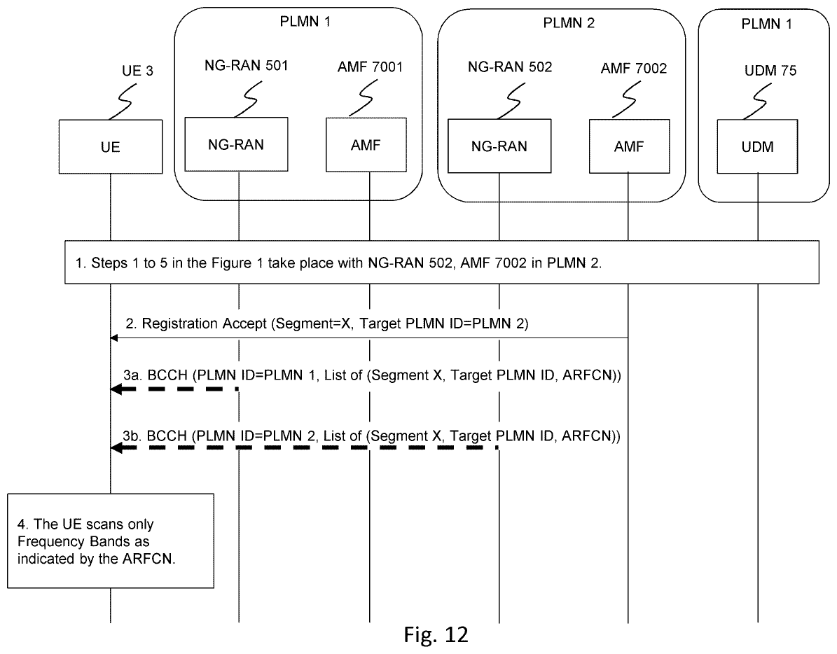

The FIG. 12 includes an example of the UE behaviour for staying in cell(s) that broadcasts a PLMN ID other than a PLMN ID of the UE 3's HPLMN based on the Segment information or PLMN ID and associated frequency bands information that is broadcasted by the cell(s).

FIG. 12: UE Retains Cells in PLMN 2 with Limited ARFCN Scanning
The detailed processes of the Fourth example of the Second Aspect are described below with reference to the FIG. 12.
Step 1. Steps 1 to 5 in the FIG. 1 for the First example of the First Aspect may take place.
Alternatively, step 1 in the FIG. 9 for the First example of the Second Aspect takes place.

Step 2. The AMF 7002 sends a Registration Accept message to the UE 3 including the Segment information and/or Target PLMN ID.

It may refer to step 5 in the FIG. 1 for detail of the Segment information and the Target PLMN ID.

For example, the Target PLMN ID may indicate a PLMN which the UE 3 needs to stay.
For example, the Target PLMN ID which is set to PLMN 2 may indicate that the UE 3 needs to stay in PLMN 2.
For example, the Target PLMN ID may indicate that the UE 3 needs to stay in cell(s) in a PLMN indicated by the Target PLMN ID.

For example, the Target PLMN ID which is set to PLMN 2 may indicate that the UE 3 needs to stay in cell(s) of PLMN 2.

Step 3a. Cell(s) that are connected to the NG-RAN 501 broadcast its PLMN ID which is set to PLMN 1 and a List of the Segment information (e.g., Segment “X”), Target PLMN ID and ARFCN combination (e.g., a List including a combination(s) of the Segment information which is set to “X”, the Target PLMN ID and the ARFCN).

The List may be a List of the Segment information and the ARFCN combination (e.g., a List including a combination(s) of the Segment information which is set to “X” and the ARFCN).

The List may be a List of the Target PLMN ID and ARFCN combination (e.g., a List including a combination(s) of The Target PLMN ID and the ARFCN).
Note that the broadcasting message in step 3a may be constantly broadcasted by cell(s) that are connected to the NG-RAN 501.
At least one of the PLMN ID and the List may be broadcasted over BCCH (e.g., SIB1). For example, at least one of the PLMN ID which is set to PLMN 1 and the List may be included in the SIB 1. For example, the NG-RAN 501 may broadcast the SIB 1. For example, the NG-RAN 501 may broadcast the SIB 1 on the cell(s) that are connected to the NG-RAN 501.
For example, the AMF 7001 may send, to the NG-RAN 501, the Segment information and the RFSP index in the same manner as step 3 in the FIG. 11. In addition, the AMF 7001 may also send, to the NG-RAN 501, the Target PLMN ID received from the UDM 75. For example, the NG-RAN 501 may convert the received RFSP index to the ARFCN in the same manner as step 4 in the FIG. 11. Then the NG-RAN 501 may make the List based on the received Segment information, the Target PLMN ID and the ARFCN. For example, the NG-RAN 501 may associate the Segment information which is set to “X”, the Target PLMN ID and the ARFCN to make the combination, and may include the combination in the List. For example, in a case where the NG-RAN 501 receives the Segment information, the Target PLMN ID and the RFSP index in one message (e.g., the INITIAL CONTEXT SETUP REQUEST message), the NG-RAN 501 may determine that these received parameters are associated each other. Then, the NG-RAN 501 may convert the RFSP index to the ARFCN, and make the combination of the received Segment information, the received Target PLMN ID and the ARFCN converted from the received RFSP index.

For example, in a case where the AMF 7001 sends, to the NG-RAN 501, the Segment information, the Target PLMN ID and the RFSP index, the NG-RAN 501 may send a List including a combination(s) of the Segment information, the Target PLMN ID and the ARFCN.

In this case, the NG-RAN 501 may convert the received RFSP index in the List to the ARFCN, and may make the List including a combination(s) of the Segment information, the Target PLMN ID and the ARFCN.

Step 3b. Cell(s) that are connected to the NG-RAN 502 broadcast its PLMN ID which is set to PLMN 2 and a List of the Segment information (e.g., Segment “X”), Target PLMN ID and ARFCN combination (e.g., a List including a combination(s) of the Segment information which is set to “X”, the Target PLMN ID and the ARFCN).

The List may be a List of Segment “X” and ARFCN combination (e.g., a List including a combination(s) of the Segment information which is set to “X” and the ARFCN). The List may be a List of Target PLMN ID and ARFCN combination (e.g., a List including a combination(s) of the Target PLMN ID and the ARFCN). Note that the broadcasting message in step 3b may be constantly broadcasted by cell(s) that are connected to the NG-RAN 502.
At least one of the PLMN ID and the List may be broadcasted over BCCH (e.g., SIB1). For example, at least one of the PLMN ID which is set to PLMN 2 and the List may be included in the SIB 1. For example, the NG-RAN 502 may broadcast the SIB 1. For example, the NG-RAN 502 may broadcast the SIB 1 on the cell(s) that are connected to the NG-RAN 502.
In the same manner as the NG-RAN 501, the NG-RAN 502 may make the List based on the received parameters from the AMF 7002 (e.g., the Segment information, the Target PLMN ID and the RFSP index).

Step 4. The UE 3 reads the List of the Segment information (e.g., Segment “X”), the Target PLMN ID and the ARFCN combination broadcasted over the BCCH (e.g., in SIB1) by the NG-RAN 501 and the NG-RAN 502. Then the UE 3 finds combination(s) including the Segment information, the Target PLMN ID and the AFRCN corresponding to the Segment information and/or Target PLMN ID in the Registration Accept message in step 2.

For example, it assumes that the List includes the combination (or an entry) of the Segment “X”, PLMN 2 and ARFCN 1, and it assumes that the UE 3 receives the Registration Accept message including Segment “X” and PLMN 2. In this case, the UE 3 may find or identify ARFCN 1.
If the UE 3 finds one or some matches (e.g., in a case where the UE 3 finds the matched ARFCN(s)), the UE 3 performs scanning or background scanning only the frequency band(s) that are matched with or corresponding to the ARFCN(s) found by the UE 3 as far as the UE 3 is subscribed with the Segment which is set to “X”. For example, the UE 3 may scan only the frequency band(s) that are matched with or corresponding to the ARFCN, therefore, it can reduce power consumption of the UE 3.

For example, the UE 3 may determine that the UE 3 is subscribed with the Segment which is set to “X” in the same manner as step 5 in the FIG. 11. In a case where the UE 3 receives (or listens to) the broadcasted PLMN ID which is set to PLMN 2 on the frequency band(s) that are indicated by the ARFCN (e.g., the above-mentioned ARFCN 1), the UE 3 may determine that the UE 3 is in the cell(s) for PLMN 2, may stay in the cell(s) for PLMN 2, and may stop the timer T in the same manner as the First example of the Second Aspect.

In addition, the mechanism may be applied to the Second example of the Second Aspect. For example, in the Second example of the Second Aspect, the UE 3 may receive (or listens to) the broadcasted PLMN ID which is set to PLMN 2 on the frequency band(s) that are indicated by the ARFCN.
According to at least one of the Second Aspect and the variants in the Second Aspect, it can solve the above-mentioned problem.

For example, at least one of the Second Aspect and the variants in the Second Aspect can solve the problem that according to the latest 3GPP mobility management functionalities, the UE has to stay in a cell that broadcasts a PLMN ID of the HPLMN as far as the UE can access to that cell.

For example, at least one of the Second Aspect and the variants in the Second Aspect can solve the problem that according to the latest 3GPP mobility management functionalities, (1) the UE has to stay in the cell that broadcasts the PLMN ID of the HPLMN, and (2) the UE has to move back to the cell that broadcasts a PLMN ID of the HPLMN when the UE is in a cell that does not broadcast the PLMN ID of the HPLMN.

For example, at least one of the Second Aspect and the variants in the Second Aspect can solve the problem that the latest 3GPP specification(s) may not meet the new service requirement.
For example, according to at least one of the Second Aspect and the variants of the Second Aspect, the UE 3 can stay in PLMN 2 which is different from PLMN 1 (e.g., the HPLMN of the UE 3) by using for example, the timer T stop indication, the RVAS PLMN list etc.
Therefore, it can solve the above-mentioned problem.
For example, according to at least one of the Second Aspect and the variants of the Second Aspect, the UE 3 can find PLMN 2 (e.g., cell(s) of PLMN 2) by scanning only the frequency band(s) indicated by the network, and stay in PLMN 2 which is different from PLMN 1 (e.g., the HPLMN of the UE 3). Therefore, it can solve the above-mentioned problem with reducing power consumption of the UE 3.

### System Overview

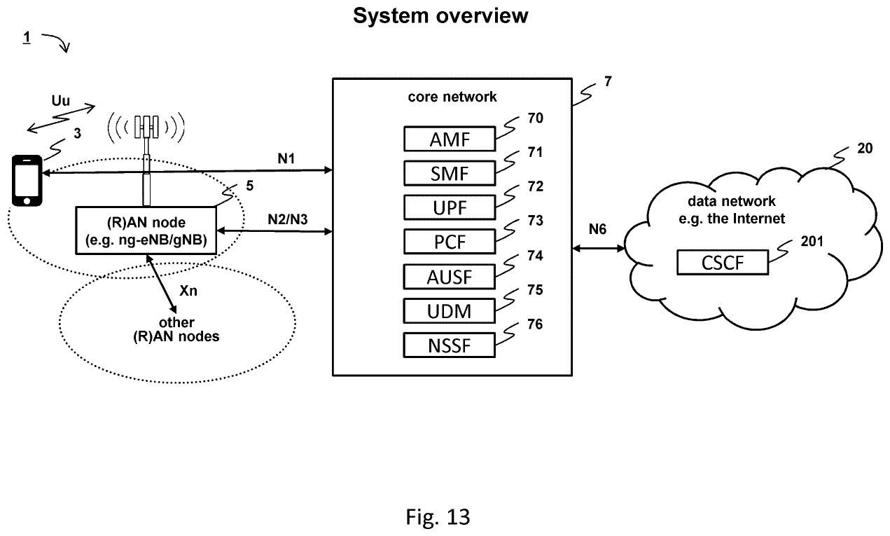

FIG. 13 schematically illustrates a telecommunication system 1 for a mobile (cellular or wireless) to which the above aspects are applicable.
The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.
The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).
The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively. The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).
The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV). The core network 7 may support the Non-Public Network (NPN). The NPN may be a Standalone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice Selection Function (NSSF) 76.

When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPV6, IPv4v6, Ethernet or unstructured data type. The data network may include a CSCF 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.
For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-STMSI-Part1 or randomValue.
RRC Setup message: This message is sent from the (R)AN node 5 to the UE 3.
   In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeasAvailable, mobilityState, ng-5G-S-TMSIPart2, registeredAMF, selectedPLMN-Identity

The UE 3 and the AMF 70 are connected via an appropriate interface (for example the socalled N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration,
Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70.
   In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### FIG. 13: System Overview

### User Equipment (UE)

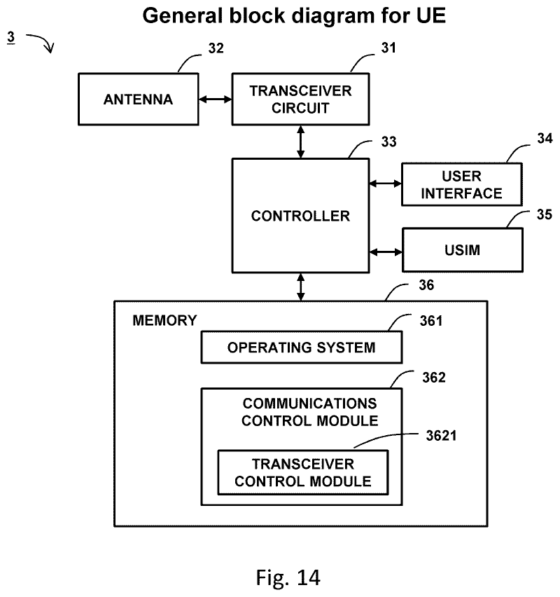

FIG. 14 is a block diagram illustrating the main components of the UE 3 (mobile device 3).

As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN). The NPN may be a Stand-alone Non-Public Network (SNPN) or a Public Network Integrated NPN (PNI-NPN). The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time.
IoT devices may be implemented as a part of a (generally) stationary apparatus. IoT devices may also be embedded in non-stationary apparatus (e.g. vehicles) or attached to animals or persons to be monitored/tracked.
It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).
The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### FIG. 14: User Equipment (UE)

### (R)AN Node

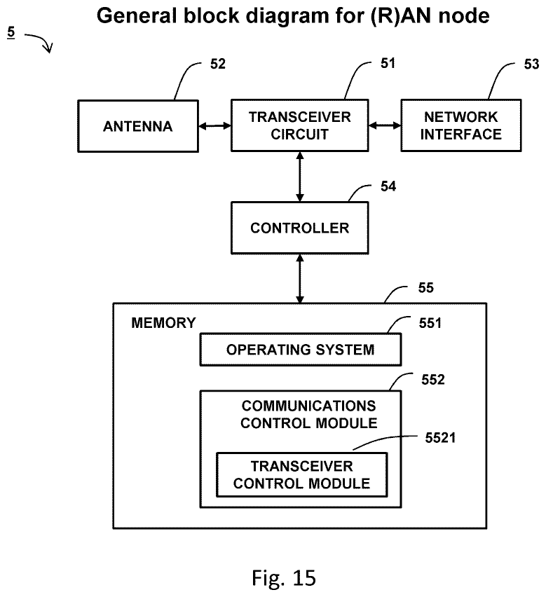

FIG. 15 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation. The (R)AN node 5 may support the Non-Public Network (NPN), The NPN may be a Standalone Non-Public Network (SNPN) or a Public Network Integrated NPN (PNI-NPN). The NG-RAN 5, the NG-RAN 501 and the NG-RAN 502 may have same components to the (R)AN node 5. The (R)AN node 5 may be expressed as a RAN node, RAN, (R)AN, NG-RAN etc.

### FIG. 15: (R)AN Node

### System Overview of (R)AN Node 5 Based on O-RAN Architecture

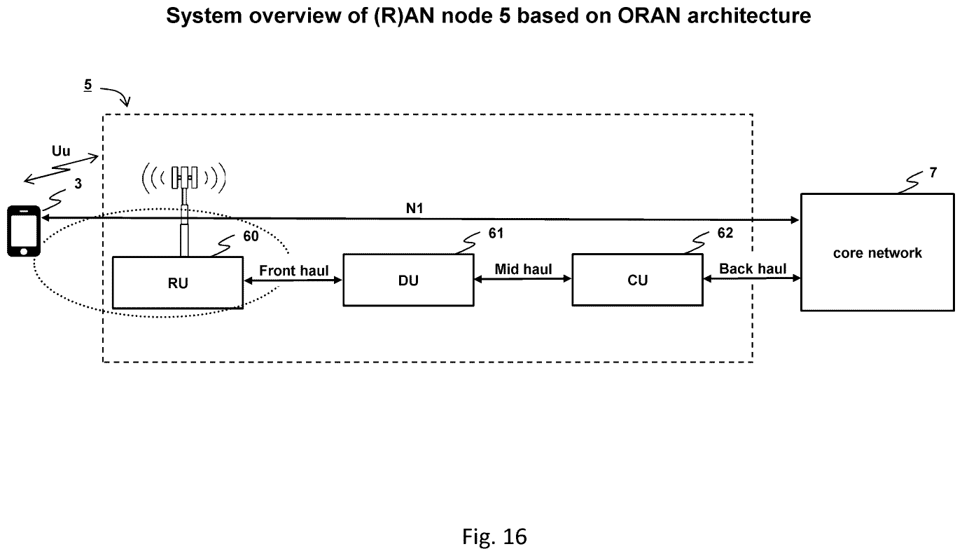

FIG. 16 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### FIG. 16: System Overview of (R)AN Node 5 Based on O-RAN Architecture

### Radio Unit (RU)

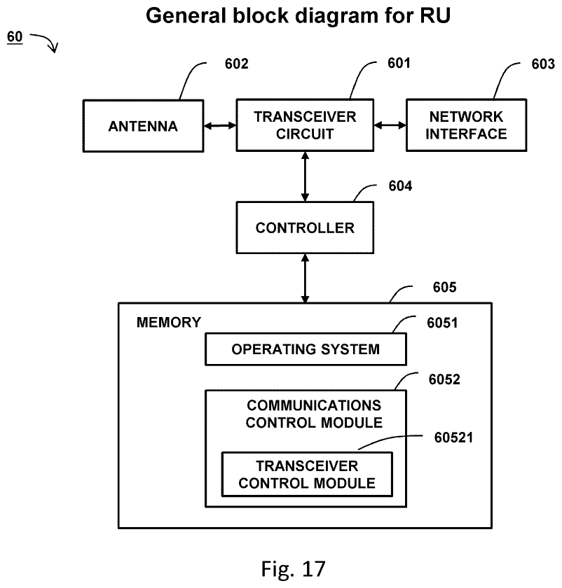

FIG. 17 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example.

The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.
The controller 604 is also configured (by software or hardware) to handle related tasks such as, when implemented, UE mobility estimate and/or moving trajectory estimation.
The RU 60 may support the Non-Public Network (NPN), The NPN may be a Stand-alone Non-Public Network (SNPN) or a Public Network Integrated NPN (PNI-NPN).
As described above, the RU 60 can be integrated/combined with the DU 61 as an integrated/combined unit. Any functionality in the description for the RU 60 can be implemented in the integrated/combined unit above.

### FIG. 17: Radio Unit (RU)

### Distributed Unit (DU)

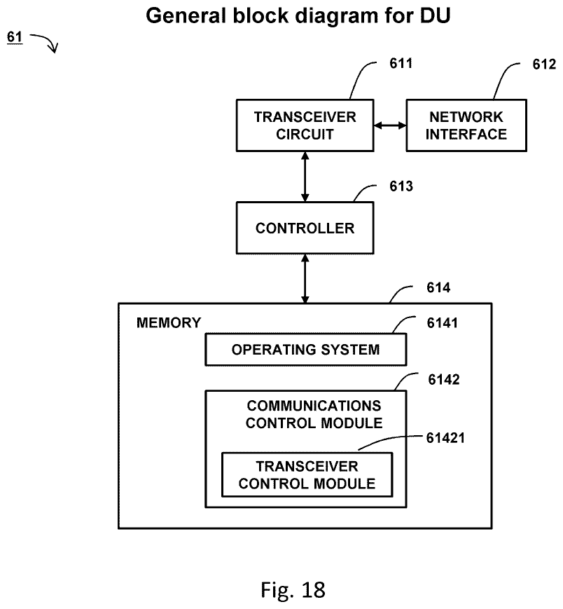

FIG. 18 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421) is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN). As described above, the RU 60 can be integrated/combined with the DU 61 or CU 62 as an integrated/combined unit. Any functionality in the description for DU 61 can be implemented in one of the integrated/combined unit above.

### FIG. 18: Distributed Unit (DU)

### Centralized Unit (CU)

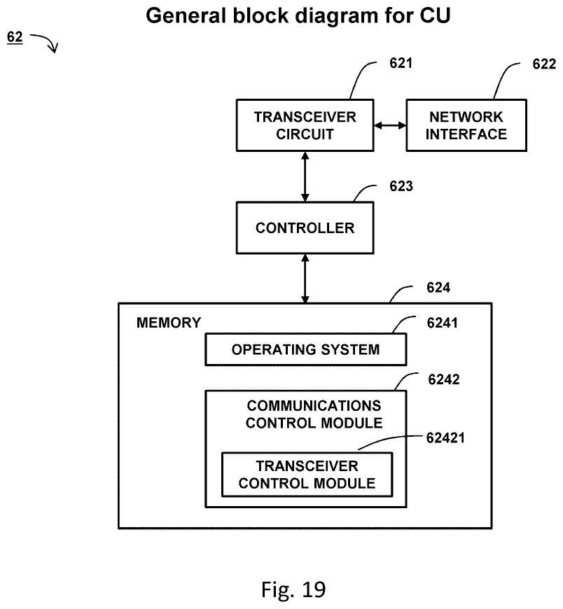

FIG. 19 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421) is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### FIG. 19: Centralized Unit (CU)

### AMF

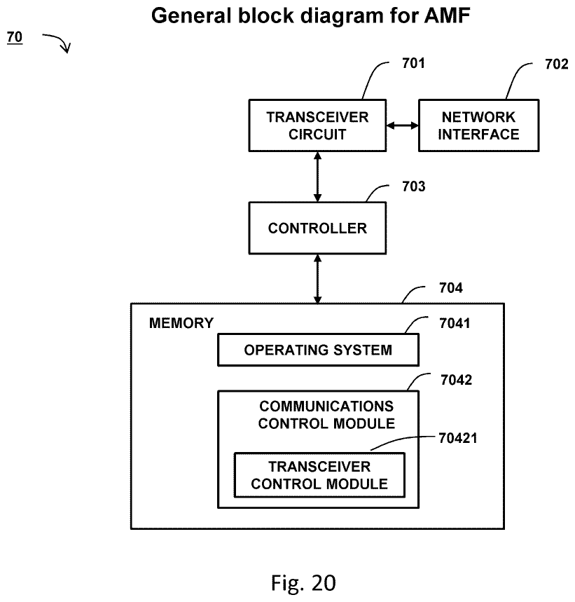

FIG. 20 is a block diagram illustrating the main components of the AMF 70. As shown, the apparatus includes a transceiver circuit 701 which is operable to transmit signals to and to receive signals from other nodes (including the UE 3, the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421) is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in). Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). The AMF 7001 and the AMF 7002 may have same components to the AMF 70.

### FIG. 20: AMF

### SMF

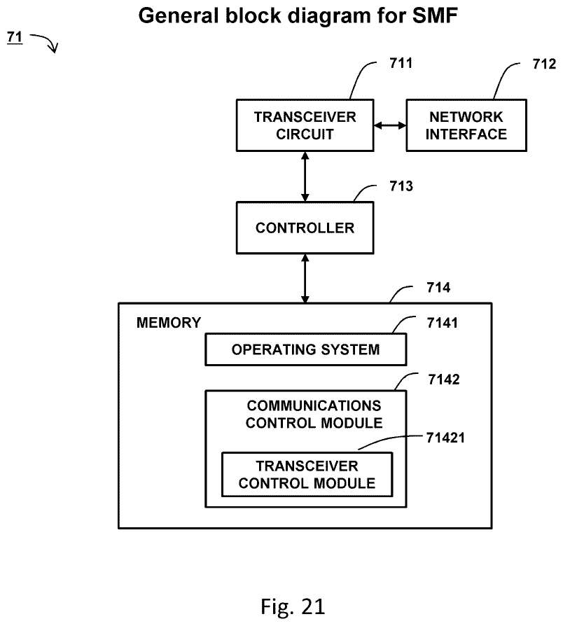

FIG. 21 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example.

The software includes, among other things, an operating system 7141 and a communications control module 7142 having at least a transceiver control module 71421.
The communications control module 7142 (using its transceiver control module 71421) is responsible for handling (generating/sending/receiving) signalling between the SMF 71 and other nodes, such as the UPF 72 and other core network nodes (including core network nodes in the HPLMN of the UE 3 when the UE 3 is roaming-in). Such signalling may include, for example, appropriately formatted signalling messages (e.g. a Hypertext Transfer Protocol (HTTP) restful methods based on the service based interfaces) relating to session management procedures (for the UE 3).
The SMF 71 may support the Non-Public Network (NPN), The NPN may be a Stand-alone Non-Public Network (SNPN) or a Public Network Integrated NPN (PNI-NPN).
The SMF 7101 and the SMF 7102 may have same components to the SMF 71.

### FIG. 21: SMF

### PCF

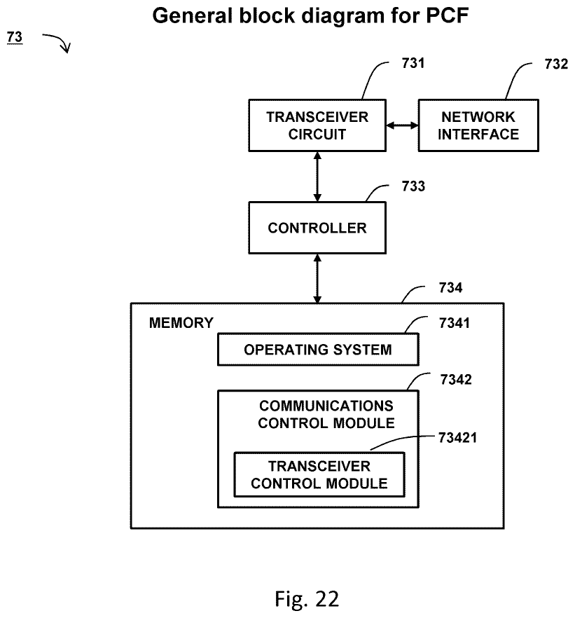

FIG. 22 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421) is responsible for handling (generating/sending/receiving) signalling between the PCF 73 and other nodes, such as the AMF 70 and other core network nodes (including core network nodes in the HPLMN of the UE 3 when the UE 3 is roaming-in). Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### FIG. 22: PCF

### AUSF

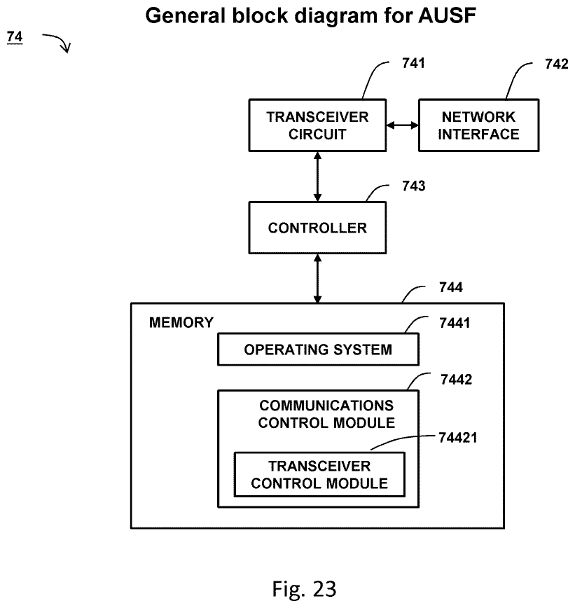

FIG. 23 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421) is responsible for handling (generating/sending/receiving) signalling between the AUSF 74 and other nodes, such as the AMF 70 and other core network nodes (including core network nodes in the HPLMN of the UE 3 when the UE 3 is roaming-in). Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### FIG. 23: AUSF

### UDM

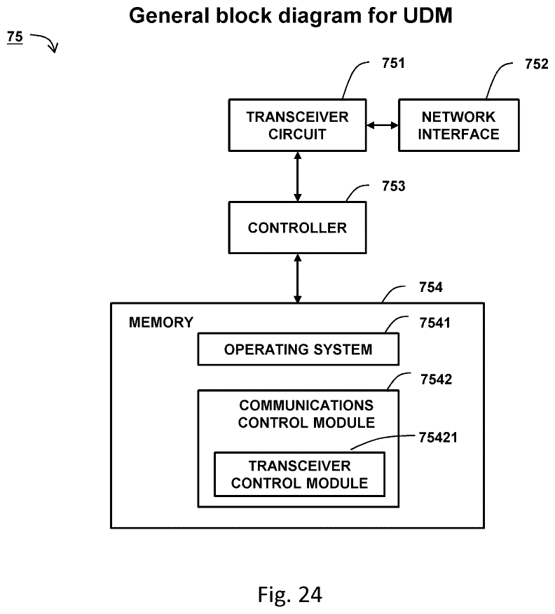

FIG. 24 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421) is responsible for handling (generating/sending/receiving) signalling between the UDM 75 and other nodes, such as the AMF 70 and other core network nodes (including core network nodes in the VPLMN of the UE 3 when the UE 3 is roaming-out). Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).
The UDM in PLMN 2 may have same components to the UDM 75.

### FIG. 24: UDM

### NSSF

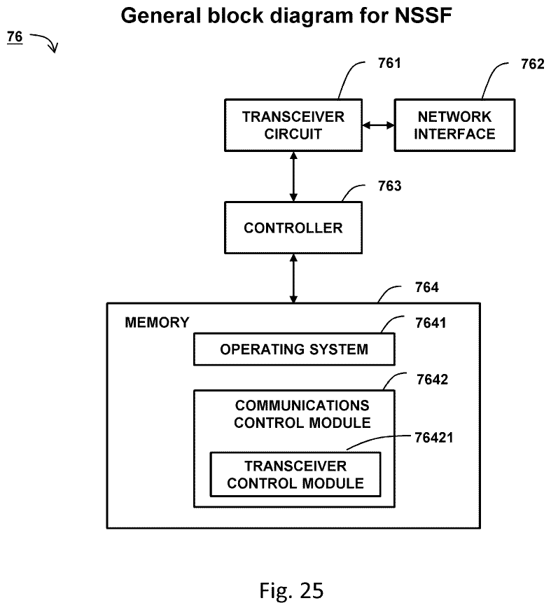

FIG. 25 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421) is responsible for handling (generating/sending/receiving) signalling between the NSSF 76 and other nodes, such as the AMF 70 and other core network nodes (including core network nodes in the VPLMN of the UE 3 when the UE 3 is roaming-out). Such signalling may include, for example, appropriately formatted signalling messages (e.g. a HTTP restful methods based on the service based interfaces) relating to mobility management procedures (for the UE 3).

The NSSF 76 may support the Non-Public Network (NPN), The NPN may be a Stand-alone Non-Public Network (SNPN) or a Public Network Integrated NPN (PNI-NPN).

### FIG. 25: NSSF

The whole or part of the example Aspects disclosed above can be described as, but not limited to, the following.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.
Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.
In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used.

However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects. Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IOT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.
Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure.

Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.

### (Supplementary Note 1)

A method of a user equipment (UE), the method comprising:
receiving a first message from a communication apparatus in a first Public Land Mobile Network (PLMN),
wherein the first message includes first information indicating that a registration procedure is required, and at least one of second information regarding a segment and third information regarding a second PLMN other than the first PLMN,
wherein the segment indicates a group of a subscriber, or that the UE is included in the group, or an area where a service for the UE is provided, and
wherein the third information indicates the second PLMN to which the UE needs to perform the registration procedure; and
sending a second message,
wherein the second message includes a registration request message and at least one of the second information and the third information.

### (Supplementary Note 2)

The method according to Supplementary note 1, further comprising: sending fourth information indicating that the UE supports to receive the first message.

### (Supplementary Note 3)

The method according to Supplementary note 1 or 2,
wherein the first message is a registration reject message, and
wherein the second message is a Radio Resource Control (RRC) Setup Complete message.

### (Supplementary Note 4)

A method of a first communication apparatus in a first Public Land Mobile Network (PLMN), the method comprising:
receiving a first message from a user equipment (UE),
wherein the first message includes a registration request message and at least one of first information regarding a segment and second information regarding a second PLMN other than a first PLMN of the first communication apparatus,
wherein the segment indicates a group of a subscriber, or the UE is included in the group, or an area where a service for the UE is provided, and
wherein the second information indicates the second PLMN to which the UE needs to perform a registration procedure;
selecting a second communication apparatus in the second PLMN based on the first information and the second information; and
sending a second message to the second communication apparatus,
wherein the second message includes the registration request message.

### (Supplementary Note 5)

The method according to Supplementary note 4, further comprising:
sending third information indicating that the first communication apparatus supports to select the second communication apparatus,
wherein the receiving the first message includes receiving the first message in a case of sending the third information.

### (Supplementary Note 6)

The method according to Supplementary note 4 or 5,
wherein the first message is a Radio Resource Control (RRC) Setup Complete message, and
wherein the second message is an Initial UE message.

### (Supplementary Note 7)

The method according to any one of supplementary notes 4 to 6,
wherein the first communication apparatus is a NG-RAN node,
wherein the second communication apparatus is an Access and Mobility Management Function (AMF).

### (Supplementary Note 8)

A method of a first communication apparatus in a first Public Land Mobile Network (PLMN), the method comprising:
receiving a first message from a second communication apparatus,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure; and
sending a second message to the UE,
wherein the second message includes third information indicating that the registration procedure is required and at least one of the first information and the second information.

### (Supplementary Note 9)

The method according to Supplementary note 8, further comprising:
sending fourth information indicating that the first communication apparatus supports to receive the first message,
wherein the receiving the first message includes receiving the first message in a case of sending the fourth information.

### (Supplementary Note 10)

The method according to Supplementary note 8 or 9, further comprising:
receiving fifth information indicating that the UE supports to receive the second message,
wherein the sending the second message includes sending the second message in a case of receiving the fifth information.

### (Supplementary Note 11)

The method according to any one of Supplementary notes 8 to 10,
wherein the first message is a Nudm_SDM_Get Response message, and
wherein the second message is a registration reject message.

### (Supplementary Note 12)

The method according to any one of Supplementary notes 8 to 11,
wherein the first communication apparatus is an Access and Mobility Management Function (AMF), and
wherein the second communication apparatus is a Unified Data Management (UDM).

### (Supplementary Note 13)

A method of a first communication apparatus in a first Public Land Mobile Network (PLMN), the method comprising:
communicating with a second communication apparatus; and
sending a message to the second communication apparatus,
wherein the message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure.

### (Supplementary Note 14)

The method according to Supplementary note 13, further comprising:
receiving fourth information indicating that the second communication apparatus supports to receive the message,
wherein the sending the message includes sending the message in a case of receiving the fourth information.

### (Supplementary Note 15)

The method according to Supplementary note 13 or 14, wherein the message is a Nudm_SDM_Get Response message.

### (Supplementary Note 16)

The method according to any one of Supplementary notes 13 to 15,
wherein the first communication apparatus is a Unified Data Management (UDM),
   and
wherein the second communication apparatus is an Access and Mobility Management Function (AMF).

### (Supplementary Note 17)

The method according to any one of Supplementary notes 13 to 16, further comprising:
sending another message to the second communication apparatus in a case where the at least one of the first information and the second information are updated,
wherein the another message includes at least one of the updated first information and the updated second information.

### (Supplementary Note 18)

A method of a first communication apparatus in a first Public Land Mobile Network (PLMN), the method comprising:
receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
selecting a second communication apparatus in the second PLMN based on the first information and the second information; and
sending a second message to the second communication apparatus,
wherein the second message includes third information to request to assign a 5G Globally Unique Temporary Identifier (5G-GUTI);
receiving the 5G-GUTI; and
sending, to the UE, the 5G-GUTI and fourth information indicating that the registration procedure is required.

### (Supplementary Note 19)

The method according to Supplementary note 18,
wherein the first communication apparatus is a first Access and Mobility Management Function (AMF),
wherein the second communication apparatus is a second AMF.

### (Supplementary Note 20)

A method of a first communication apparatus in a first Public Land Mobile Network (PLMN), the method comprising:
receiving a message from a second communication apparatus in a second PLMN,
wherein the message includes information to request to assign a 5G Globally Unique Temporary Identifier (5G-GUTI); and
sending the 5G-GUTI.

### (Supplementary Note 21)

The method according to Supplementary note 20,
wherein the first communication apparatus is a first Access and Mobility Management Function (AMF),
wherein the second communication apparatus is a second AMF.

### (Supplementary Note 22)

A method of a first communication apparatus in a first Public Land Mobile Network (PLMN), the method comprising:
receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
selecting a second communication apparatus in the second PLMN based on the first information and the second information;
sending a second message to the second communication apparatus,
wherein the second message includes third information to request to assign a 5G Globally Unique Temporary Identifier (5G-GUTI);
receiving the 5G-GUTI;
sending the 5G-GUTI; and
sending fourth information indicating that the registration procedure is required to the UE.

### (Supplementary Note 23)

The method according to Supplementary note 22,
wherein the first communication apparatus is a first Access and Mobility Management Function (AMF),
wherein the second communication apparatus is a second AMF.

### (Supplementary Note 24)

A method of a user equipment (UE), the method comprising:
receiving a message from a communication apparatus in a first Public Land Mobile Network (PLMN),
wherein the message includes information indicating that a registration procedure is required and a 5G Globally Unique Temporary Identifier (5G-GUTI), and
wherein the 5G-GUTI is assigned in a second PLMN; and
performing the registration procedure based on the 5G-GUTI.

### (Supplementary Note 25)

The method according to Supplementary note 24,
wherein the message is a registration accept message.

### (Supplementary Note 26)

A method of a user equipment (UE), the method comprising:
receiving a first message from a communication apparatus in a first Public Land Mobile Network (PLMN),
wherein the first message includes a 5G Globally Unique Temporary Identifier (5GGUTI), and
wherein the 5G-GUTI is assigned in a second PLMN;
receiving a second message,
wherein the second message includes information indicating that a registration procedure is required; and
performing the registration procedure based on the 5G-GUTI.

### (Supplementary Note 27)

The method according to Supplementary note 26,
wherein the first message is a registration accept message, and
wherein the second message is a de-registration request message.

### (Supplementary Note 28)

A method of a first communication apparatus in a first Public Land Mobile Network (PLMN), the method comprising:
receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
selecting a second communication apparatus in the second PLMN based on the first information and the second information; and
sending, to the second communication apparatus, a second message to instruct the second communication apparatus to perform the registration procedure for the UE.

### (Supplementary Note 29)

The method according to Supplementary note 28,
wherein the first communication apparatus is a first Access and Mobility Management Function (AMF),
wherein the second communication apparatus is a second AMF.

### (Supplementary Note 30)

A method of a first communication apparatus in a first Public Land Mobile Network (PLMN), the method comprising:
receiving, from a second communication apparatus in a second PLMN, a first message to perform a registration procedure for a user equipment; and
performing the registration procedure.

### (Supplementary Note 31)

The method according to Supplementary note 30,
wherein the first communication apparatus is a first Access and Mobility Management Function (AMF),
wherein the second communication apparatus is a second AMF.

### (Supplementary Note 32)

A method of a first communication apparatus in a first Public Land Mobile Network (PLMN), the method comprising:
receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and wherein the second information indicates the second PLMN to which the UE needs to perform a registration procedure;
receiving a second message to establish a Protocol Data Unit (PDU) session from the UE;
selecting a second communication apparatus in the second PLMN based on the first information and the second information; and
sending, to the second communication apparatus, a third message to establish the PDU session.

### (Supplementary Note 33)

The method according to Supplementary note 32,
wherein the first message is an Nudm_SDM_Get Response message,
wherein the second message is a UL NAS TRANSPORT message, and
wherein the third message is an Nsmf_PDUSession_CreateSMContext Request message.

### (Supplementary Note 34)

The method according to Supplementary note 32 or 33,
wherein the first communication apparatus is an Access and Mobility Management Function (AMF), and
wherein the second communication apparatus is a Session Management Function (SMF).

### (Supplementary Note 35)

The method according to any one of Supplementary notes 32 to 34,
wherein the first communication apparatus is a first Access and Mobility Management Function (AMF), and
wherein the second communication apparatus is a second AMF.

### (Supplementary Note 36)

A method of a first communication apparatus in a first Public Land Mobile Network (PLMN), the method comprising:
receiving a message to establish a Protocol Data Unit (PDU) session from a second communication apparatus in a second PLMN; and
performing a procedure to establish the PDU session.

### (Supplementary Note 37)

The method according to Supplementary note 36,
wherein the message is an Nsmf_PDUSession_CreateSMContext Request message.

### (Supplementary Note 38)

The method according to Supplementary note 36 or 37,
wherein the first communication apparatus is a Session Management Function (SMF), and
wherein the second communication apparatus is an Access and Mobility Management Function (AMF).

### (Supplementary Note 39)

A method of a first communication apparatus in a first Public Land Mobile Network (PLMN), the method comprising:
receiving a first message to establish a Protocol Data Unit (PDU) session from a second communication apparatus in a second PLMN; and
sending a second message to establish the PDU session to a third communication apparatus in the first PLMN.

### (Supplementary Note 40)

The method according to Supplementary note 39,
wherein the first message is an Namf_Communication_NIMessageNotify message, and
wherein the second message is an Nsmf_PDUSession_CreateSMContext Request message.

### (Supplementary Note 41)

The method according to Supplementary note 39 or 40,
wherein the first communication apparatus is a first Access and Mobility Management Function (AMF),
wherein the second communication apparatus is a second AMF, and
wherein the third communication apparatus is a Session Management Function (SMF).

### (Supplementary Note 42)

A method of a user equipment (UE), the method comprising:
communicating with a communication apparatus; and
keeping staying in a first Public Land Mobile Network (PLMN) by stopping a timer or by ignoring expiry of the timer or by overriding the timer in a case where the UE is in the first PLMN and a second PLMN,
wherein the timer is configured to make the UE to return to the second PLMN in a case of expiry of the timer, and
wherein the second PLMN is a Home Public Land Mobile Network (HPLMN) of the UE.

### (Supplementary Note 43)

The method according to Supplementary note 42,
wherein the stopping is performed by information to stop the timer.

### (Supplementary Note 44)

The method according to Supplementary note 42 or 43, further comprising: determining whether the UE is in the first PLMN by scanning a PLMN ID which is set to the first PLMN.

### (Supplementary Note 45)

The method according to Supplementary note 44, further comprising:
receiving information indicating a frequency band,
wherein the scanning the PLMN ID which is set to the first PLMN includes scanning the PLMN ID which is set to the first PLMN on the frequency band.

### (Supplementary Note 46)

A method of a user equipment (UE), the method comprising:
communicating with a communication apparatus; and
keeping staying in a first Public Land Mobile Network (PLMN) by using a PLMN list related to a Roaming Value Added Service (RVAS) in a case where the UE is in the first PLMN and a second PLMN,
wherein the first PLMN is included in the PLMN list,
wherein the PLMN list indicates that the first PLMN is selected for the RVAS in preference to the second PLMN, and
wherein the second PLMN is a Home Public Land Mobile Network (HPLMN) of the UE.

### (Supplementary Note 47)

The method according to Supplementary note 46, further comprising:
determining whether the UE is in the first PLMN by scanning a PLMN ID which is set to the first PLMN.

### (Supplementary Note 48)

The method according to Supplementary note 47, further comprising:
receiving information indicating a frequency band,
wherein the scanning the PLMN ID which is set to the first PLMN includes scanning the PLMN ID which is set to the first PLMN on the frequency band.

### (Supplementary Note 49)

A user equipment (UE) comprising:
means for receiving a first message from a communication apparatus in a first Public Land Mobile Network (PLMN),
wherein the first message includes first information indicating that a registration procedure is required, and at least one of second information regarding a segment and third information regarding a second PLMN other than the first PLMN,
wherein the segment indicates a group of a subscriber, or that the UE is included in the group, or an area where a service for the UE is provided, and
wherein the third information indicates the second PLMN to which the UE needs to perform the registration procedure; and means for sending a second message,
wherein the second message includes a registration request message and at least one of the second information and the third information.

### (Supplementary Note 50)

The UE according to Supplementary note 49, further comprising:
means for sending fourth information indicating that the UE supports to receive the first message.

### (Supplementary Note 51)

The UE according to Supplementary note 49 or 50,
wherein the first message is a registration reject message, and
wherein the second message is a Radio Resource Control (RRC) Setup Complete message.

### (Supplementary Note 52)

A first communication apparatus in a first Public Land Mobile Network (PLMN) comprising:
means for receiving a first message from a user equipment (UE),
wherein the first message includes a registration request message and at least one of first information regarding a segment and second information regarding a second PLMN other than a first PLMN of the first communication apparatus,
wherein the segment indicates a group of a subscriber, or the UE is included in the group, or an area where a service for the UE is provided, and
wherein the second information indicates the second PLMN to which the UE needs to perform a registration procedure;
means for selecting a second communication apparatus in the second PLMN based on the first information and the second information; and
means for sending a second message to the second communication apparatus,
wherein the second message includes the registration request message.

### (Supplementary Note 53)

The first communication apparatus according to Supplementary note 52, further comprising:
means for sending third information indicating that the first communication apparatus supports to select the second communication apparatus; and
means for receiving the first message in a case of sending the third information.

### (Supplementary Note 54)

The first communication apparatus according to Supplementary note 52 or 53,
wherein the first message is a Radio Resource Control (RRC) Setup Complete message, and
wherein the second message is an Initial UE message.

### (Supplementary Note 55)

The first communication apparatus according to any one of Supplementary notes 52 to 54,
wherein the first communication apparatus is a NG-RAN node,
wherein the second communication apparatus is an Access and Mobility Management Function (AMF).

### (Supplementary Note 56)

A first communication apparatus in a first Public Land Mobile Network (PLMN) comprising:
means for receiving a first message from a second communication apparatus,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure; and
means for sending a second message to the UE,
wherein the second message includes third information indicating that the registration procedure is required and at least one of the first information and the second information.

### (Supplementary Note 57)

The first communication apparatus according to Supplementary note 56, further comprising:
means for sending fourth information indicating that the first communication apparatus supports to receive the first message; and
means for receiving the first message in a case of sending the fourth information.

### (Supplementary Note 58)

The first communication apparatus according to Supplementary note 56 or 57, further comprising:
means for receiving fifth information indicating that the UE supports to receive the second message; and
means for sending the second message in a case of receiving the fifth information.

### (Supplementary Note 59)

The first communication apparatus according to any one of Supplementary notes 56 to 58,
wherein the first message is a Nudm_SDM_Get Response message, and
wherein the second message is a registration reject message.

### (Supplementary Note 60)

The first communication apparatus according to any one of Supplementary notes 56 to 59,
wherein the first communication apparatus is an Access and Mobility Management Function (AMF), and
wherein the second communication apparatus is a Unified Data Management (UDM).

### (Supplementary Note 61)

A first communication apparatus in a first Public Land Mobile Network (PLMN) comprising:
means for communicating with a second communication apparatus; and
means for sending a message to the second communication apparatus,
wherein the message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure.

### (Supplementary Note 62)

The first communication apparatus according to Supplementary note 61, further comprising:
means for receiving fourth information indicating that the second communication apparatus supports to receive the message; and
means for sending the message in a case of receiving the fourth information.

### (Supplementary Note 63)

The first communication apparatus according to Supplementary note 61 or 62,
wherein the message is a Nudm_SDM_Get Response message.

### (Supplementary Note 64)

The first communication apparatus according to any one of Supplementary notes 61 to 63,
wherein the first communication apparatus is a Unified Data Management (UDM), and
wherein the second communication apparatus is an Access and Mobility Management Function (AMF).

### (Supplementary Note 65)

The first communication apparatus according to any one of Supplementary notes 61 to 64, further comprising:
means for sending another message to the second communication apparatus in a case where the at least one of the first information and the second information are updated,
wherein the another message includes at least one of the updated first information and the updated second information.

### (Supplementary Note 66)

A first communication apparatus in a first Public Land Mobile Network (PLMN) comprising:
means for receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
means for selecting a second communication apparatus in the second PLMN based on the first information and the second information; and
means for sending a second message to the second communication apparatus,
wherein the second message includes third information to request to assign a 5G Globally Unique Temporary Identifier (5G-GUTI);
means for receiving the 5G-GUTI; and
means for sending, to the UE, the 5G-GUTI and fourth information indicating that the registration procedure is required.

### (Supplementary Note 67)

The first communication apparatus according to Supplementary note 66,
wherein the first communication apparatus is a first Access and Mobility Management Function (AMF),
wherein the second communication apparatus is a second AMF.

### (Supplementary Note 68)

A first communication apparatus in a first Public Land Mobile Network (PLMN) comprising:
means for receiving a message from a second communication apparatus in a second PLMN,
wherein the message includes information to request to assign a 5G Globally Unique Temporary Identifier (5G-GUTI); and
means for sending the 5G-GUTI.

### (Supplementary Note 69)

The first communication apparatus according to Supplementary note 68,
wherein the first communication apparatus is a first Access and Mobility Management Function (AMF),
wherein the second communication apparatus is a second AMF.

### (Supplementary Note 70)

A first communication apparatus in a first Public Land Mobile Network (PLMN) comprising:
means for receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
means for selecting a second communication apparatus in the second PLMN based on the first information and the second information;
means for sending a second message to the second communication apparatus,
wherein the second message includes third information to request to assign a 5G Globally Unique Temporary Identifier (5G-GUTI);
means for receiving the 5G-GUTI;
means for sending the 5G-GUTI; and
means for sending fourth information indicating that the registration procedure is required to the UE.

### (Supplementary Note 71)

The first communication apparatus according to Supplementary note 70,
wherein the first communication apparatus is a first Access and Mobility Management Function (AMF),
wherein the second communication apparatus is a second AMF.

### (Supplementary Note 72)

A user equipment (UE) comprising:
means for receiving a message from a communication apparatus in a first Public Land Mobile Network (PLMN),
wherein the message includes information indicating that a registration procedure is required and a 5G Globally Unique Temporary Identifier (5G-GUTI), and
wherein the 5G-GUTI is assigned in a second PLMN; and
means for performing the registration procedure based on the 5G-GUTI.

### (Supplementary Note 73)

The UE according to Supplementary note 72,
wherein the message is a registration accept message.

### (Supplementary Note 74)

A user equipment (UE) comprising:
means for receiving a first message from a communication apparatus in a first Public Land Mobile Network (PLMN),
wherein the first message includes a 5G Globally Unique Temporary Identifier (5GGUTI),
   and
wherein the 5G-GUTI is assigned in a second PLMN;
means for receiving a second message,
wherein the second message includes information indicating that a registration procedure is required; and
means for performing the registration procedure based on the 5G-GUTI.

### (Supplementary Note 75)

The UE according to Supplementary note 74,
wherein the first message is a registration accept message, and
wherein the second message is a de-registration request message.

### (Supplementary Note 76)

A first communication apparatus in a first Public Land Mobile Network (PLMN) comprising:
means for receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
means for selecting a second communication apparatus in the second PLMN based on the first information and the second information; and
means for sending, to the second communication apparatus, a second message to instruct the second communication apparatus to perform the registration procedure for the UE.

### (Supplementary Note 77)

The first communication apparatus according to Supplementary note 76,
wherein the first communication apparatus is a first Access and Mobility Management Function (AMF),
wherein the second communication apparatus is a second AMF.

### (Supplementary Note 78)

A first communication apparatus in a first Public Land Mobile Network (PLMN) comprising:
means for receiving, from a second communication apparatus in a second PLMN, a first message to perform a registration procedure for a user equipment; and
means for performing the registration procedure.

### (Supplementary Note 79)

The first communication apparatus according to Supplementary note 78,
wherein the first communication apparatus is a first Access and Mobility Management Function (AMF),
wherein the second communication apparatus is a second AMF.

### (Supplementary Note 80)

A first communication apparatus in a first Public Land Mobile Network (PLMN) comprising:
means for receiving a first message,
wherein the first message includes at least one of first information regarding a segment and second information regarding a second PLMN other than the first PLMN,
wherein the segment indicates a group of a subscriber, or a user equipment (UE) is included in the group, or an area where a service for the UE is provided, and
wherein the second information indicates the second PLMN to which the UE needs to perform a registration procedure;
means for receiving a second message to establish a Protocol Data Unit (PDU) session from the UE;
means for selecting a second communication apparatus in the second PLMN based on the first information and the second information; and
means for sending, to the second communication apparatus, a third message to establish the PDU session.

### (Supplementary Note 81)

The first communication apparatus according to Supplementary note 80,
wherein the first message is an Nudm_SDM_Get Response message,
wherein the second message is a UL NAS TRANSPORT message, and
wherein the third message is an Nsmf_PDUSession_CreateSMContext Request message.

### (Supplementary Note 82)

The first communication apparatus according to Supplementary note 80 or 81,
wherein the first communication apparatus is an Access and Mobility Management Function (AMF), and
wherein the second communication apparatus is a Session Management Function (SMF).

### (Supplementary Note 83)

The first communication apparatus according to any one of Supplementary notes 80 to 82,
wherein the first communication apparatus is a first Access and Mobility Management Function (AMF), and
wherein the second communication apparatus is a second AMF.

### (Supplementary Note 84)

A first communication apparatus in a first Public Land Mobile Network (PLMN) comprising:
means for receiving a message to establish a Protocol Data Unit (PDU) session from a second communication apparatus in a second PLMN; and
means for performing a procedure to establish the PDU session.

### (Supplementary Note 85)

The first communication apparatus according to Supplementary note 84, wherein the message is an Nsmf_PDUSession_CreateSMContext Request message.

### (Supplementary Note 86)

The first communication apparatus according to Supplementary note 84 or 85,
wherein the first communication apparatus is a Session Management Function (SMF), and
wherein the second communication apparatus is an Access and Mobility Management Function (AMF).

### (Supplementary Note 87)

A first communication apparatus in a first Public Land Mobile Network (PLMN) comprising:
means for receiving a first message to establish a Protocol Data Unit (PDU) session from a second communication apparatus in a second PLMN; and
means for sending a second message to establish the PDU session to a third communication apparatus in the first PLMN.

### (Supplementary Note 88)

The first communication apparatus according to Supplementary note 87,
wherein the first message is an Namf_Communication_NIMessageNotify message,
   and
wherein the second message is an Nsmf_PDUSession_CreateSMContext Request message.

### (Supplementary Note 89)

The first communication apparatus according to Supplementary note 87 or 88,
wherein the first communication apparatus is a first Access and Mobility Management Function (AMF),
wherein the second communication apparatus is a second AMF, and
wherein the third communication apparatus is a Session Management Function (SMF).

### (Supplementary Note 90)

A user equipment (UE) comprising:
means for communicating with a communication apparatus; and
means for keeping staying in a first Public Land Mobile Network (PLMN) by stopping a timer or by ignoring expiry of the timer or by overriding the timer in a case where the UE is in the first PLMN and a second PLMN,
wherein the timer is configured to make the UE to return to the second PLMN in a case of expiry of the timer, and
wherein the second PLMN is a Home Public Land Mobile Network (HPLMN) of the UE.

### (Supplementary Note 91)

The UE according to Supplementary note 90,
wherein the stopping is performed by information to stop the timer.

### (Supplementary Note 92)

The UE according to Supplementary note 90 or 91, further comprising:
means for determining whether the UE is in the first PLMN by scanning a PLMN ID which is set to the first PLMN.

### (Supplementary Note 93)

The UE according to Supplementary note 92, further comprising:
means for receiving information indicating a frequency band; and
means for scanning the PLMN ID which is set to the first PLMN on the frequency band.

### (Supplementary Note 94)

A user equipment (UE) comprising:
means for communicating with a communication apparatus; and
means for keeping staying in a first Public Land Mobile Network (PLMN) by using a PLMN list related to a Roaming Value Added Service (RVAS) in a case where the UE is in the first PLMN and a second PLMN,
wherein the first PLMN is included in the PLMN list,
wherein the PLMN list indicates that the first PLMN is selected for the RVAS in preference to the second PLMN, and
wherein the second PLMN is a Home Public Land Mobile Network (HPLMN) of the UE.

### (Supplementary Note 95)

The UE according to Supplementary note 94, further comprising:
means for determining whether the UE is in the first PLMN by scanning a PLMN ID which is set to the first PLMN.

### (Supplementary Note 96)

The UE according to Supplementary note 95, further comprising:
means for receiving information indicating a frequency band; and
means for scanning the PLMN ID which is set to the first PLMN on the frequency band.

### (Supplementary Note 97)

A method of a communication apparatus in a first Public Land Mobile Network (PLMN) comprising:
communicating with a user equipment (UE); and
sending, to the UE, information to indicate to stop a timer or to ignore expiry of the timer or to override the timer,
wherein the timer is configured to make the UE to return to a second PLMN in a case of expiry of the timer, and
wherein the second PLMN is a Home Public Land Mobile Network (HPLMN) of the UE.

### (Supplementary Note 98)

The method according to Supplementary note 97, further comprising:
sending, to the UE, information indicating a frequency band to be scanned by the UE.

### (Supplementary Note 99)

A communication apparatus in a first Public Land Mobile Network (PLMN) comprising:
means for communicating with a user equipment (UE); and
means for sending, to the UE, information to indicate to stop a timer or to ignore expiry of the timer or to override the timer,
wherein the timer is configured to make the UE to return to a second PLMN in a case of expiry of the timer, and
wherein the second PLMN is a Home Public Land Mobile Network (HPLMN) of the UE.

### (Supplementary Note 100)

The communication apparatus according to Supplementary note 99, further comprising:
means for sending, to the UE, information indicating a frequency band to be scanned by the UE.

### (Supplementary Note 101)

A method of a communication apparatus in a first Public Land Mobile Network (PLMN) comprising:
communicating with a user equipment (UE); and
sending a PLMN list related to a Roaming Value Added Service (RVAS) to make the UE to stay in the first PLMN,
wherein the first PLMN is included in the PLMN list,
wherein the PLMN list indicates that the first PLMN is selected for the RVAS in preference to a second PLMN, and
wherein the second PLMN is a Home Public Land Mobile Network (HPLMN) of the UE.

### (Supplementary Note 102)

The method according to Supplementary note 101, further comprising: sending, to the UE, information indicating a frequency band to be scanned by the UE.

### (Supplementary Note 103)

A communication apparatus in a first Public Land Mobile Network (PLMN) comprising:
means for communicating with a user equipment (UE); and
means for sending a PLMN list related to a Roaming Value Added Service (RVAS) to make the UE to stay in the first PLMN,
wherein the first PLMN is included in the PLMN list,
wherein the PLMN list indicates that the first PLMN is selected for the RVAS in preference to a second PLMN, and
wherein the second PLMN is a Home Public Land Mobile Network (HPLMN) of the UE.

### (Supplementary Note 104)

The communication apparatus according to Supplementary note 103, further comprising:
means for sending, to the UE, information indicating a frequency band to be scanned by the UE.

### (Supplementary Note 105)

A method of a communication apparatus in a first Public Land Mobile Network (PLMN) comprising:
communicating with a user equipment (UE); and
sending first information regarding a second PLMN other than the first PLMN and second information regarding a frequency band,
wherein the first information indicates the second PLMN in which the UE needs to stay, and
wherein the second information indicate the frequency band which the UE needs to scan.

### (Supplementary Note 106)

A communication apparatus in a first Public Land Mobile Network (PLMN) comprising:
means for communicating with a user equipment (UE); and
means for sending first information regarding a second PLMN other than the first PLMN and second information regarding a frequency band,
wherein the first information indicates the second PLMN in which the UE needs to stay, and
wherein the second information indicate the frequency band which the UE needs to scan.

This application is based upon and claims the benefit of priority from Indian Patent Application number 202311015789, filed on Mar. 9, 2023, the disclosure of which is incorporated herein in its entirety by reference.

### REFERENCE SIGNS LIST

3 UE
5 NG-RAN
7 Core Network
20 data network
33 controller
35 USIM
36 memory
71 Session Management Function (SMF)
72 User Plane Function (UPF)
73 Policy Control Function (PCF)
74 Authentication Server Function (AUSF)
75 Unified Data Management (UDM)
76 Network Slice Selection Function (NSSF)
7001 AMF
7002 AMF
7101 SMF
7102 SMF

What is claimed is:

1-4. (canceled)

5. A method of a user equipment (UE), the method comprising:
communicating with a communication apparatus; and
keeping staying in a first Public Land Mobile Network (PLMN) by using a PLMN list related to a Roaming Value Added Service (RVAS) in a case where the UE is in the first PLMN and a second PLMN,
wherein the first PLMN is included in the PLMN list,
wherein the PLMN list indicates that the first PLMN is selected for the RVAS in preference to the second PLMN, and
wherein the second PLMN is a Home Public Land Mobile Network (HPLMN) of the UE.

6. The method according to claim 5, further comprising:
determining whether the UE is in the first PLMN by scanning a PLMN ID which is set to the first PLMN.

7. The method according to claim 6, further comprising:
receiving information indicating a frequency band,
wherein the scanning the PLMN ID which is set to the first PLMN includes scanning the PLMN ID which is set to the first PLMN on the frequency band.

8-11. (canceled)

12. A user equipment (UE) comprising:
at least one memory storing instructions; and
at least one processor configured to execute the instructions to:
communicate with a communication apparatus; and
stay in a first Public Land Mobile Network (PLMN) by using a PLMN list related to a Roaming Value Added Service (RVAS) in a case where the UE is in the first PLMN and a second PLMN,
wherein the first PLMN is included in the PLMN list,
wherein the PLMN list indicates that the first PLMN is selected for the RVAS in preference to the second PLMN, and
wherein the second PLMN is a Home Public Land Mobile Network (HPLMN) of the UE.

13-18. (canceled)

19. A method of a communication apparatus in a first Public Land Mobile Network (PLMN) comprising:
communicating with a user equipment (UE); and
sending a PLMN list related to a Roaming Value Added Service (RVAS) to make the UE to stay in the first PLMN,
wherein the first PLMN is included in the PLMN list,
wherein the PLMN list indicates that the first PLMN is selected for the RVAS in preference to a second PLMN, and
wherein the second PLMN is a Home Public Land Mobile Network (HPLMN) of the UE.

20. The method according to claim 19, further comprising:
sending, to the UE, information indicating a frequency band to be scanned by the UE.

21-24. (canceled)
